(19) United States
(12) Patent Application Publication
(10) Pub. No.: US 2013/0202762 A1
(43) Pub. Date: Aug. 8, 2013

(54) BEER ADDITIVE AND METHOD

(71) Applicant: Ian David KAEHNE, Belair (AU)

(72) Inventor: Ian David KAEHNE, Belair (AU)

(21) Appl. No.: 13/832,610

(22) Filed: Mar. 15, 2013

Related U.S. Application Data
(63) Continuation-in-part of application No. 10/574,874, filed on Apr. 6, 2006.

(30) Foreign Application Priority Data
Oct. 8, 2003 (AU) AU2003905487
Oct. 8, 2004 (AU) PCT/AU2004/001392

(51) Int. Cl. C12C 5/02

(52) U.S. Cl. CPC C12C 5/026
USPC 426/535; 426/534; 426/477

(57) ABSTRACT

A method of enhancing the taste of a beer with a mineral additive. The mineral additive comprises soluble compounds of the following minerals to the following ranges of final concentrations of the respective element in the finished beer, to enhance taste characteristics of the diluted beer when compared to a dilution solely with water. Group A minerals: calcium from 5.9 mg/L to 236 mg/L, and magnesium from 1.3 to 52 mg/L. Group B minerals: phosphorus from 3.0 to 360 mg/L, potassium from 12 mg/L to 480 mg/L, silicon at 0.075 mg/L to 30 mg/L, sodium at 0.8 mg/L to 32 mg/L and chlorine at 0.9 mg/L to 36 mg/L. Group C minerals: boron from 0 to 76 μg/L, chromium from 0 to 0.4 μg/L, cobalt from 0 to 0.4 μg/L, copper from 0 to 17.2 μg/L, iodine from 0 to 5.2 μg/L, lithium from 0 to 1.6 μg/L, manganese from 0 to 1.6 μg/L, molybdenum from 0 to 2.0 μg/L, nickel from 0 to 2.0 μg/L, selenium from 0 to 136 μg/L, tin from 0 to 01.6 μg/L, vanadium from 0 to 0.12 μg/L and zinc from 0 to 104 μg/L. Group D minerals: iron 0 to 20 μg/L.

### RELATED U.S. APPLICATION

This application is a continuation-in-part of Ser. No. 10/574,874 filed Apr. 6, 2006, entitled “BEER ADDITIVE AND METHOD” (pending), the content of which is incorporated herein by reference, which is a US National Stage Entry of PCT/AU2004/001392 filed Oct. 8, 2004, which claims priority of Australian Application No. AU2003905487 filed Oct. 8, 2003.

### FIELD OF THE INVENTION

This invention relates to additives for beer, and in one specific aspect additives that can be used in minimising the impact, for example on taste, of diluting beers to produce low alcohol beers as well as a method of diluting beers, and in a second aspect to a method of modifying the taste profiles of beers.

### BACKGROUND TO THE INVENTION

Low alcoholic beverages, in particular beers, are returning to vogue. This follows considerable emphasis that has been placed on the role of alcohol in the impairment of driving capacity and other activities. Additionally it is considered generally desirable to reduce alcohol intake to maintain a healthy lifestyle. For brewers, production of low alcohol beers provides an avenue for reducing excise, and promoting consumption volumes.

There is a difficulty in providing a low alcohol beer whilst at the same time providing a satisfactory flavour profile. An approach adopted in the early part of the 20th century, during the so called prohibition in the United States of America, was a distillation using heat and/or vacuum to reduce the alcohol content to acceptable levels. Distillation is, however, expensive and in addition to removing alcohol it removes flavour compounds. When heat is used the taste of the undistilled portion can additionally be compromised.

Removal of alcohol by filtration such as reverse osmosis has also been suggested, however, again the process is relatively expensive and additionally can result in removal of flavour compounds with the alcohol.

A currently favoured approach is to dilute relatively full strength and high gravity beer with water. The beer may have been produced from a wort with modified characteristics in particular stronger taste and body such that subsequent dilution produces a beverage with an acceptable flavour. Such modifications include reducing the relative fermentable mass of the wort by ensuring that some of the malt is not fermentable producing an inherently lower alcohol product. A range of other approaches can also be taken to attempt to give the low alcohol beverage as acceptable a taste as possible. Inevitably, however it has not been possible to fully compensate for flavour dilution with water or natural mineral waters, particularly where significant dilutions are required.

Use of additives have also been suggested for enhancing the flavour of beers in particular low alcohol base beers in which some of the flavour components have been depleted. It is thus suggested by Heusen, U.S. Pat. No. 1,401,700, to add a small quantity of volatile acids such as formic, acetic and propionic acids. Witt et al., U.S. Pat. No. 4,788,066, suggest that for the low alcohol beer disclosed therein that mash water should preferably contain certain salts to enhance the flavour and exemplifies potassium phosphate and potassium hydro phosphate salts to provide a level of potassium between 200 to 600 parts per million.

Additionally, in beer making generally, there is a problem with maintaining flavours between batches of product and typically beers on the market are blends. It is desirable to either have a more consistent flavour in full strength beers or to improve the flavour.

### SUMMARY OF THE INVENTION

It has been found, according to this invention, that the addition of certain levels of a complex mixture of minerals enhances the capacity to dilute beers by compensating somewhat for the reduction and disruption of flavours and taste characteristics (profiles) commensurate with dilution. Additionally, it is found that by the addition of the complex of minerals to beers of all strengths that flavour and taste perceptions are enhanced.

In a broad form of a first aspect the invention may be said to reside in a method of diluting a base beer with a mineral additive and water the base beer being diluted to between 0.5% and 90%, the mineral additive including soluble compounds of the following minerals to the following ranges of final concentrations in the finished beer of the respective element, to enhance taste characteristics of the diluted beer when compared to a dilution solely with water:—
group A minerals: calcium from 5.9 mg/L to 236 mg/L, and magnesium from 1.3 to 52 mg/L
group B minerals: phosphorus from 3.0 to 360 mg/L, potassium from 12 mg/L to 480 mg/L, silicon at 0.075 mg/L to 30 mg/L, sodium at 0.8 mg/L to 32 mg/L and chlorine at 0.9 mg/L to 36 mg/L,
group C minerals: boron from 0 to 76 μg/L, chromium from 0 to 0.4 μg/L, cobalt from 0 to 0.4 μg/L, copper from 0 to 17.2 μg/L, iodine from 0 to 5.2 μg/L, lithium from 0 to 1.6 μg/L, manganese from 0 to 1.6 μg/L, molybdenum from 0 to 2.0 μg/L, nickel from 0 to 2.0 μg/L, selenium from 0 to 136 μg/L, tin from 0 to 01.6 μg/L, vanadium from 0 to 0.12 μg/L and zinc from 0 to 104 μg/L,
group D minerals: iron 0 to 20 μg/L.

Preferably for the group C minerals boron is added in the range of 5.0 to 76 μg/L of beer, chromium is added in the range of 0.04 to 0.4 μg/L of beer, cobalt is added in the range of 0.025 to 0.4 μg/L of beer, copper is added in the range of 1.1 to 17.2 μg/L of beer, iodine is added in the range of 0.3 to 5.2 μg/L of beer, lithium is added in the range of 0.1 to 1.6 μg/L of beer, manganese is added in the range of 0.1 to 1.6 μg/L of beer, molybdenum is added in the range of 0.1 to 2.0 μg/L of beer, nickel is added in the range of 0.025 to 2.0 μg/L of beer, selenium is added in the range of 7.0 to 136 μg/L of beer, tin is added in the range of 0.1 to 1.6 μg/L of beer, vanadium is added in the range of 0.01 to 0.12 μg/L of beer and zinc is added in the range of 7.0 to 104 μg/L of beer; and
for the group D minerals iron is added in the range of 1.0 to 20 μg/L of beer.

Alternatively all the minerals of groups A, B, C and D are added in dry form with minimal impact on dilution, or some of the minerals can be added as a solution whereas others can be added in dry form.

It is found that various types of beers benefit most from the addition of minerals at a diverse range of concentrations. Typically preferred ranges of the final elemental concentrations in some types of beers are set out below.

For a stout beer the minerals might typically be added to a final concentration in the beer as follows:

group A minerals: calcium from 70 mg/L to 143 mg/L, and magnesium from 15 mg/L to 32 mg/L
group B minerals: phosphorus at least 36 mg/L, potassium from 144 mg/L to 288 mg/L, silicon at 9 mg/L to 18 mg/L, sodium at 9 mg/L to 20 mg/L and chlorine at 11 mg/L to 22 mg/L,
group C minerals: boron from 23 to 46 μg/L, chromium from 0.12 to 0.24 μg/L, cobalt from 0.12 to 0.24 μg/L, copper from 5 to 11 μg/L, iodine from 1.5 to 3.5 μg/L, lithium from 0.45 to 1.00 μg/L, manganese from 0.45 to 1.00 μg/L, molybdenum from 0.6 to 1.2 μg/L, nickel from 0.6 to 1.2 μg/L, selenium from 40 to 82 μg/L, tin from 0.45 to 1.00 μg/L, vanadium from 0.035 to 0.075 μg/L and zinc from 31 to 62 μg/L,
group D minerals: iron 6 to 12 μg/L.

For a pilsner beer the minerals might typically be added to a final concentration in the beer as follows:

group A minerals: calcium from 188 mg/L to 224 mg/L, and magnesium from 41 mg/L to 50 mg/L
group B minerals: phosphorus at least 96 mg/L, potassium from 380 mg/L to 460 mg/L, silicon at 24 mg/L to 29 mg/L, sodium at 25 mg/L to 31 mg/L and chlorine at 28 mg/L to 35 mg/L,
group C minerals: boron from 60 to 73 μg/L, chromium from 0.3 to 0.4 μg/L, cobalt from 0.3 to 0.4 μg/L, copper from 13 to 17 μg/L, iodine from 4 to 5 μg/L, lithium from 1.2 to 1.6 μg/L, manganese from 1.2 to 1.6 μg/L, molybdenum from 1.5 to 2.0 μg/L, nickel from 1.5 to 2.0 μg/L, selenium from 40 to 82 μg/L, tin from 1.2 to 1.6 μg/L, vanadium from 0.09 to 0.12 μg/L and zinc from 83 to 99 μg/L,
group D minerals: iron 16 to 19 μg/L.

For a light beer (typically, 2.5-3.5% alcohol content) the minerals might typically be added to a final concentration in the beer as follows:

group A minerals: calcium from 11 mg/L to 21 mg/L, and magnesium from 2.6 to 4.6 mg/L
group B minerals: phosphorus at least 6 mg/L, potassium from 24 mg/L to 42 mg/L, silicon at 1.5 mg/L to 2.7 mg/L, sodium at 1.5 mg/L to 2.8 mg/L and chlorine at 1.8 mg/L to 3.2 mg/L,
group C minerals: boron from 3.5 to 7 μg/L, chromium from 0.02 to 0.035 μg/L, cobalt from 0.02 to 0.035 μg/L, copper from 0.8 to 1.6 μg/L, iodine from 0.25 to 0.5 μg/L, lithium from 0.08 to 0.14 μg/L, manganese from 0.08 to 0.14 μg/L, molybdenum from 0.1 to 0.18 μg/L, nickel from 0.1 to 0.18 μg/L, selenium from 6.8 to 12 μg/L, tin from 0.08 to 0.14 μg/L, vanadium from 0.006 to 0.011 μg/L and zinc from 5 to 9.5 μg/L,
group D minerals: iron 1 to 1.8 μg/L.

For an extra light beer (typically about 1% alcohol content) the minerals might typically be added to a final concentration in the beer as follows:

group A minerals: calcium from 23 mg/L to 42 mg/L, and magnesium from 5 to 9.5 mg/L
group B minerals: phosphorus at least about 12 mg/L, potassium from 48 mg/L to 84 mg/L, silicon at 3 mg/L to 5.3 mg/L, sodium at 3.2 mg/L to 5.6 mg/L and chlorine at 3.6 mg/L to 6.3 mg/L,
group C minerals: boron from 7.5 to 14 μg/L, chromium from 0.04 to 0.07 μg/L, cobalt from 0.04 to 0.07 μg/L, copper from 1.7 to 3.2 μg/L, iodine from 0.5 to 1.0 μg/L, lithium from 0.15 to 0.3 μg/L, manganese from 0.15 to 0.3 μg/L, molybdenum from 0.2 to 0.35 μg/L, nickel from 0.2 to 0.35 μg/L, selenium from 13 to 24 μg/L, tin from 0.15 to 0.3 μg/L, vanadium from 0.012 to 0.021 μg/L and zinc from 10 to 19 μg/L,
group D minerals: iron 1 to 3.5 μg/L.

For a medium strength beer (typically, 4-5% alcohol content) the minerals might typically be added to a final concentration in the beer as follows:

group A minerals: calcium from 11 mg/L to 23 mg/L, and magnesium from 2.6 to 5 mg/L
group B minerals: phosphorus at least about 6 mg/L, potassium from 24 mg/L to 48 mg/L, silicon at 1.5 mg/L to 3 mg/L, sodium at 1.6 mg/L to 3.2 mg/L and chlorine at 6.8 mg/L to 3.6 mg/L,
group C minerals: boron from 3.5 to 8 μg/L, chromium from 0.02 to 0.04 μg/L, cobalt from 0.02 to 0.04 μg/L, copper from 0.8 to 1.8 μg/L, iodine from 0.25 to 0.5 μg/L, lithium from 0.08 to 0.15 μg/L, manganese from 0.08 to 0.15 μg/L, molybdenum from 0.1 to 0.2 μg/L, nickel from 0.1 to 0.2 μg/L, selenium from 6.8 to 13 μg/L, tin from 0.08 to 0.15 μg/L, vanadium from 0.005 to 0.012 μg/L and zinc from 5 to 10 μg/L,
group D minerals: iron 1 to 2 μg/L.

For a full strength ale (typically, 5-7% alcohol content) the minerals might typically be added to a final concentration in the beer as follows:

group A minerals: calcium from 17 mg/L to 36 mg/L, and magnesium from 3.9 to 7.8 mg/L
group B minerals: phosphorus at least about 9 mg/L, potassium from 36 mg/L to 72 mg/L, silicon at 2.2 mg/L to 4.5 mg/L, sodium at 2.4 mg/L to 4.8 mg/L and chlorine at 2.5 mg/L to 5.5 mg/L,
group C minerals: boron from 5.5 to 11.5 μg/L, chromium from 0.03 to 0.06 μg/L, cobalt from 0.03 to 0.06 μg/L, copper from 1.2 to 2.6 μg/L, iodine from 0.3 to 0.8 μg/L, lithium from 0.12 to 0.24 μg/L, manganese from 0.12 to 0.24 μg/L, molybdenum from 0.15 to 0.3 μg/L, nickel from 0.15 to 0.3 μg/L, selenium from 10 to 21 μg/L, tin from 0.12 to 0.24 μg/L, vanadium from 0.009 to 0.02 μg/L and zinc from 7.5 to 16 μg/L,
group D minerals: iron 1.5 to 3 μg/L.

The mineral additives preferably has elements present in certain proportions by element weight as follows:
group A; calcium from 25 to 82 and magnesium from 6 to 18,
group B; potassium from 50 to 180, silicon from 0.45 to 1.5, sodium from 3 to 30, chlorine from 3 to 28,
group C; boron from 0 to 0.060, chromium from 0 to 0.0005, cobalt from 0 to 0.0005, copper from 0 and 0.012, iodine from 0 to 0.006, lithium from 0 to 0.0015, manganese from 0 to 0.0015, molybdenum from 0 to 0.0015, nickel from 0 to 0.0005, selenium from 0 to 0.100, tin from 0 to 0.0015, vanadium from 0 to 0.1 and zinc from 0 and 0.100,
group D: Iron from 0 to 0.020,

A preferred range of proportions of the group A elements in the mineral additive preparation are as follows, calcium from 44 to 74 and magnesium from 10 to 16. The most preferable proportion of calcium is about 59 and the most preferable proportion of magnesium is about 13.

A preferred range of proportions of the group B elements in the mineral additive preparation are as follows; potassium from 80 to 150, silicon from 0.55 to 1.0, sodium from 5 to 15, chlorine from 5 to 14.

A most preferred proportion of each group B element is as follows; potassium is about 120, silicon is about 0.75, sodium is about 8, and chlorine is about 9 mg/L.

A preferred range of proportion of the group C elements in the mineral additive preparation are as follows; boron from 0.010 to 0.040, chromium from 0.00005 to 0.0002, cobalt from 0.00005 to 0.0002, copper from 2 to 9, iodine from 0.0004 to 0.0025, lithium from 0.0001 to 0.0010, manganese from 0.0001 to 0.0010, molybdenum from 0.0001 to 0.0010, nickel from 0.00005 to 0.0002, selenium from 0.010 to 0.070, tin from 0.0001 to 0.0010, vanadium from 0.00001 to 0.00007 and zinc from 0.010 to 0.070.

A most preferred proportion of each group C element is as follows; boron is about 0.019, chromium is about 0.0001, cobalt is about 0.0001, copper is about 0.0043, iodine is about 0.0013, lithium is about 0.0004, manganese is about 0.0004, molybdenum is about 0.0005, nickel is about 0.0001, selenium is about 0.034, tin is about 0.0004, vanadium is about 0.00003 and zinc is about 0.026.

A preferred range of proportions the group D element present in the mineral additive preparation is as follows: iron is from 0.002 to 0.012, and most preferably about 0.005.

It might be desired to add only group A and B elements and these may be added at to their preferred or most preferred levels, and perhaps also added by way of an additive in their preferred or most preferred proportions. All or some of the group C and D elements may also be added. Those elements from group C and D that are more preferred to be present are boron, copper, iodine, selenium, zinc and iron.

Preferably the mineral additive is made up as separate aqueous preparations of the group A, B, C and D minerals. These could be added separately to the beer or perhaps as two or more preparations combined such as perhaps groups A and B combined or perhaps C and D combined or A alone and B, C and D combined.

Alternatively the mineral additive is prepared by first making a preparation of group A minerals followed by the addition of the minerals of the other groups.

The pH of the preparation is of importance because the pH of beer is an important characteristic. It is preferred that any buffer or acid is added to the group A minerals either as a separate preparation or before the addition of other mineral to make up a combined preparation. Alternatively buffer may be added to one or more of the preparations B, C and D separately or combined in addition to being added to group A.

The pH is adjusted preferably in the range of 3.5 through to 5.0 and preferably no higher than 4.7. More preferably the pH is about 3.8 to about 4.5.

Where the pH of a preparation of either the group A minerals or the mineral additive preparation is brought below about 4.5, 4.4, 4.3, 4.3, 4.1 or 4.0 it is preferred that the suspension of Ca and Mg is brought into solution. Addition of carbon dioxide might be used where the pH is sought to be brought to a level of about 4.2 to 4.4 or greater. This is particularly the case when using a range of concentrations of calcium of up to about 100 mg/L or 240 mg/L. Where it is desired to use a preparation more concentrated, carbon dioxide does not provide sufficient buffering capacity under reasonable working pressures to bring the pH down to the above levels. Organic or mineral acids might be utilised instead. Thus citric, lactic, malic, tartaric, fumaric or other organic acids might be used. These may be somewhat undesirable because they have a tendency, when added in significant amounts, to impact on the taste of the final beer. A taste neutral mineral acid is preferable. For example phosphoric acid is a suitable acid being generally approved for food use. Other mineral acids, such as sulphuric acid or hydrochloric acid may be used but they impact more substantially on taste than phosphoric acid.

The use of phosphoric acid has the additional benefit when used for dilution of the group A concentrate, in that it presents the calcium and magnesium as soluble phosphate compound. Additionally when phosphoric acid or other mineral acid is used this permits more ready use of calcium and magnesium as carbonates rather than hydroxides as sources of these minerals and that has benefits, if only from cost point of view. In particular where the pH of the group A mineral preparation is to be adjusted to a pH of about 4 then the difficulty presented by the use of a suspension of the calcium and magnesium compounds is obviated because these are readily solubilised at the level of acid required in the case of phosphoric acid and hydrochloric acid.

It may additionally be desired not to buffer only the group A mineral preparation. It might thus for example be desired to add sufficient acid to the group A mineral preparation to bring the calcium and magnesium compounds into solution. The remainder of the acid might be added to either one or more of the preparations of group B, C and D elements when separate or combined.

The concentration of the minerals in the mineral additive preparation will depend very much on the desired final concentration of the minerals, the level of dilution of the beer that is required, and at higher concentrations the capacity to make preparations of a particular strength.

Dilution in at one end of the spectrum might be as high as about 90% for example to produce a 0.5% alcohol beer, however typically it will however not be more than about 50%. The dilution might be less than 50% in particular when the wort used has relatively low fermentability, or its alcohol content is lower than that usually used to manufacture a full-strength beer. Dilution of such beers might be in the range of 5-50%. Alternatively the dilution might be less still where, for example, a highly concentrated or dry preparation of the minerals is to be added simply to improve the taste of a full strength beer.

Addition of the mineral additive preparation might be in two broad alternative forms. In a first form the additive might be added as a relatively dilute form, particularly where the required dilution of the beer is high. The mineral additive preparations in such first form is added to the base beer before gassing with carbon dioxide and perhaps final adjustment for pH and preferably deaerated.

In a second form the additive may be added in concentrated form relative to the final concentration in the beer, perhaps as much as 200 fold. In this second form the mineral additive is preferably added after the base beer has been diluted with water (or not), gassed and adjusted for pH. The mineral additive preparation or preparations will have its pH adjusted to coincide with that of the final beer and will be deaerated, so that it does not disturb the generally anoxic condition of the beer. This second form may additionally entail addition of one or more of the minerals in dry form.

The choices of biologically acceptable salts for each of the elements are wide and might be any of those that are acceptable for human consumption at the levels indicated. Biologically acceptable salts refer to salts of the minerals concerned that have no adverse effects on ingestion or afterwards at the levels in the beverage, and these levels will vary for each element.

There are some quite strong preferences in the source of the elements that form part of the invention. These are provided as a soluble salt and are thus provided with other elements which other elements must not be in a form that provides imbalances to the final composition or interferes with the manufacturing process. Preferably elements are maintained in a form capable of impacting on taste, thus the salts in which the elements are provided should be intercompatible and not, for example, complexed into forms that are unavailable for taste perception. Also there should be no other components that provide for significant adverse taste or health effects.

Calcium is most preferably provided or partially provided in the form of calcium hydroxide Ca(OH)₂. This is initially provided as a suspension particularly where it is provided as a concentrate. The preferred adjustment for pH is by the addition of CO₂ (carbon dioxide), which addition then converts the calcium hydroxide to calcium bicarbonate which is soluble Ca(OH)₂+2 CO₂->Ca(HCO₃)₂. Calcium hydroxide is preferably added as the primary or sole source of calcium. Other sources of calcium might also be used but these are not preferred and if used should be used as part only of the source of calcium. Thus some of the calcium might be added as CaCl₂ (calcium chloride) however this cannot be used as the sole source of calcium because the levels of calcium required would result an excess of chlorine. CaI₂ (calcium iodine) might be used as a partial source of calcium but not the sole source because otherwise an excess of iodine is provided. CaSO₄ (calcium sulphate) might be used as a partial source however not the sole source because an excess of sulphur would result in an adverse taste characteristic. Ca(H₂PO₄)₂ (monobasic calcium phosphate) might be used as a partial but not sole source, otherwise an excess of phosphorus would be provided, solubility issues arise and additionally an unacceptable risk of reaction with the preferred silicon source (SiO₃²⁻) would result. Calcium carbonate may also be used as a calcium source if a mineral acid is used to adjust the pH of the beer lower than about 5.

Magnesium is preferably provided or partially as Mg(OH)₂ (magnesium hydroxide) which as with the calcium counterpart above is insoluble but can be provided in suspension in concentrated form and is converted to Mg(HCO₃)₂ (magnesium bicarbonate) when the pH is adjusted by the addition of CO₂. Magnesium hydroxide is preferably added as the primary or sole source of magnesium. Other sources of magnesium might also be used but these are not preferred and may be used as part only of the source of magnesium. Thus MgCl₂ (magnesium chloride) might be added as a partial but not sole source because at the concentrations for providing the required level of magnesium chlorine would be provided in excess. Mg(H₂PO₄)₂ (monobasic magnesium phosphate) may also provide as a partial but not complete source of magnesium for reasons similar to why calcium cannot be provided solely in this form. MgSeO₄ (magnesium selenate) may be a partial but not sole source of magnesium because at the concentrations for providing the required level of magnesium selenium would be provided in excess. MgSO₄ (magnesium sulphate) may be a partial but not sole source of magnesium because at the required levels of magnesium an excess of sulphur, with its adverse taste characteristics, would result. Magnesium carbonate may also be used as a magnesium source if a mineral acid is used to adjust the pH of the beer lower than about 5.

Phosphorus might be provided solely or partially in the form of KH₂PO₄ (monobasic potassium phosphate) or alternatively or additionally in part by NaH₂PO₄ (monobasic sodium phosphate), the latter compound could lead to excessive levels of sodium at the concentration required if it were the sole source of phosphorus. K₂HPO₄ (dibasic potassium phosphate) may also be a partial source of phosphorus but care must be taken with the levels of potassium provided and a difficulty may be found in the handling of the compound because it is hygroscopic. Phosphorous might be additionally provided in the form of H₃PO₄ (Phosphoric Acid).

Potassium can be provided solely or partially in the form of KH₂PO₄ (monobasic potassium phosphate) or KHCO₃ (potassium bicarbonate). KCl (potassium chloride) may be a partial but not sole source of potassium because at the concentrations for providing the required level of potassium chlorine would be provided in excess. KI (potassium iodide) may be a partial but not sole source of potassium because at the concentrations for providing the required level of potassium iodine would be provided in excess. K₂MoO₄.5H₂O (potassium molybdate) may be used as a partial source of potassium, but the ease of use of this compound is complicated because it is a deliquescent powder and also excess molybdenum should be avoided. K₂HPO₄ (dibasic potassium phosphate) may also be a partial source of potassium however care must be taken with the levels of phosphorus provided and a difficulty may be found in the handling of the compound because it is hygroscopic. K₂SeO₄ (potassium selenate) may also be a partial source of potassium but its use is limited by the level of selenium that is acceptable. K₂SO₄ (potassium sulphate) might also be used as a partial source of potassium, the level being limited by the tolerated level of sulphur.

Silicon is preferably provided as Na₂SiO₃.5H₂O (sodium metasilicate).

There are a number of potential sources of sodium including NaHCO₃ (sodium bicarbonate) Na₂B₄O₇.10H₂O (sodium tetraborate), NaCl (sodium chloride), Na₂MoO₄.2H₂O (sodium molybdate), Na₂SeO₄.10H₂O (sodium selenate), Na₂SeO₃ (sodium selenite) Na₂SiO₃.5H₂O (sodium silicate) and Na₂SO₄ or Na₂SO₄.10H₂O (sodium sulphate). Sodium is commonly found in salts used for other elements central to the formulation of the present composition so that whilst some of the above compounds may be suitable to solely supply the sodium it is anticipated that two or more of these compounds will collectively provide the requisite level of sodium perhaps also in combination with other sources. In addition to the above, less preferable sources of sodium include NaH₂PO₄.H₂O or 2H₂O (monobasic sodium phosphate) and Na₂HPO₄.7H₂O (dibasic sodium phosphate).

There are also a large range of salts that might provide chlorine and these might include NaCl (sodium chloride), KCl (potassium chloride), CaCl₂ (calcium chloride) or MgCl₂ (magnesium chloride).

Boron is preferably provided in the form Na₂B₄O₇.10H₂O (sodium tetraborate) but might be provided as K₂B₄O₇.5H₂O (potassium tetraborate).

Chromium is preferably provided in the form K[Cr(SO₆H₄)₂(H₂O)₂].6H₂O (chromium potassium sulphate) which thus also will contribute as a source of potassium.

Cobalt is preferably provided as either CoK₂(SO₄)₂.6H₂O (cobaltous potassium sulphate) or CoSO₄.7H₂O (cobalt sulphate).

Copper is preferably provided in the form of CuSO₄.5H₂O (cupric sulphate) but might be provided as CuSeO₄.5H₂O (cupric selenate).

Iodine is preferably provided as (KI) potassium iodide.

Lithium is preferably provided in the form Li₂SO₄.H₂O (lithium sulphate) and this is preferably the sole source of lithium. Alternatively or additionally lithium might be added as LiCl (lithium chloride) but this compound is deliquescent and therefore must be handled accordingly. Lithium might be also added as Li₂SeO₄.H₂O (lithium selenate).

Manganese is preferably added in the form of MnSO₄.H₂O (manganous sulphate) but may be provided perhaps in part in the form of MnCl₂.4H₂O (manganous chloride).

Molybdenum is preferably added in the form of Na₂MoO₄.2H₂O (sodium molybdate) but may also be provided perhaps in part in the form of K₂MoO₄.5H₂O (potassium molybdate) the latter is however deliquescent and therefore must be handled accordingly.

Nickel is preferably added in the form NiSO₄.6H₂O (nickel sulphate) but may also be provided perhaps in part in the form NiCl₂.6H₂O (nickel chloride) the latter is however deliquescent and therefore must be handled accordingly.

Selenium is preferably added in the form Na₂SeO₄.10H₂O (sodium selenate), K₂SeO₄ (potassium selenate), MgSeO₄ (magnesium selenate) or Na₂SeO₃ (sodium selenite).

Tin is preferably added as SnCl₂.2H₂O (stannous chloride).

Vanadium is preferably added in the form of NH₄VO₃ (ammonium vanadate).

Zinc is preferably added as ZnSO₄.H₂O or ZnSO₄.7H₂O (zinc sulphate).

Iron is preferably added as FeSO₄.7H₂O (ferrous sulphate). Less preferably FeCl₂ or FeCl₂.2H₂O (ferrous chloride) might also be used; the former being hygroscopic and the latter being somewhat unstable.

It is found that the preferred compounds do not adversely complex or interfere chemically with other compounds among the components. Thus where adverse strong complexes are formed between the component minerals or where adverse reactions take place between the component parts there is a strong likelihood that the minerals may be present in a form that will not contribute to the taste profile and may produce undesirable taste characteristics.

### DETAILED DESCRIPTION OF EXEMPLIFIED EMBODIMENTS OF THE INVENTION

### Example 1

Preparative Techniques

### Preparation of Separate Group A, B, C and D Elements

The group A elements are prepared separately by suspension in purified water (B.P. grade pure water (double distilled deionized filtered)) of calcium hydroxide Ca(OH)₂ or calcium carbonate CaCO₃ and magnesium hydroxide Mg(OH)₂ or magnesium carbonate MgCO₃ in proportions of Ca:Mg required in the mineralized diluent water or in the concentrate added to finished beers. The group A concentrate preparation takes the form of a suspension. Commercially available calcium hydroxide and magnesium hydroxide may contain insoluble carbonates. These are best removed by filtering the solution of group A after addition of CO₂ or by filtering the final solution. A final solution of group A minerals requires a reactive step to achieve a solution which may produce a precipitate if mixed with B, C and D at certain concentrations and pH levels. The nature of the reactions will depend on the starting constituents and the buffer that is added and may be as follows.

Ca(OH)₂+2CO₂->Ca(HCO₃)₂ i)

Mg(OH)₂+2CO₂->Mg(HCO₃)₂ ii)

CaCO₃+CO₂+H₂O->Ca(HCO₃)₂ iii)

MgCO₃+CO₂+H₂O->Mg(HCO₃)₂ iv)

Ca(HCO₃)₂+H₃PO₄->CaHPO₄+2CO₂+2H₂O v)

Mg(HCO₃)₂+H₃PO₄->MgHPO₄+2CO₂+2H₂O vi)

Ca(OH)₂+H₃PO₄->CaHPO₄+2H₂O vii)

Mg(OH)₂+H₃PO₄->MgHPO₄+2H₂O viii)

CaCO₃+H₃PO₄->CaHPO₄+H₂O+CO₂ ix)

MgCO₃+H₃PO₄->MgHPO₄+H₂O+CO₂ x)

Thus for example as set out in reactions v) and vi), above, to achieve a solution of the calcium and magnesium a relatively dilute bicarbonate solution can be prepared by reaction with carbon dioxide either as an introduced gas or an introduced solid. Most preferably this is as set out for reactions (i) and (ii) and less preferably, although it is still feasible, using reactions (iii) and (iv) because the hydroxides are more reactive with dissolved carbon dioxide. The buffer might therefore be added to the solutions resulting from reactions (i) through iv) to reflect the reactions set out in (v) and (vi) to partially or completely convert bicarbonates to monohydrogen phosphates or the buffer may be added to the suspension of either hydroxides or carbonates as in reactions (vii) through (x). The latter four reactions could produce a range of solutions from relatively dilute mineral water containing buffer to concentrates.

A typical mineralized diluent solution of group A may be prepared by suspending 5.46 g of Ca(OH)₂ and 1.63 g of (Mg(OH)₂ per litre of water and reaction. 20 ml of the suspension is diluted to 900 ml of water with CO₂ to produce a clear solution of calcium and magnesium bicarbonates. The resulting solution of group A contains (Ca) 66.7 mg/L and (Mg) 15.1 mg/L.

A typical more concentrated solution of group A may be prepared by mixing 7.37 g of CaCO₃ and 2.36 g of MgCO₃ and 9.96 g of H₃PO₄ (added as a concentrated acid) per litre of water. After reaction the solution of group A contains (Ca) 3000 mg/L and (Mg) 680 mg/L.

Any addition of phosphoric acid buffer required in the finished product can be added to either the mineralized diluent or more concentrated form of group A as required by experimentation to achieve the desired pH in the treated beer. Typically about 5 to 15 g of H₃PO₄ is required per litre of concentrate (see above) or about 0.1 to 0.75 g of H₃PO₄ per litre of mineralized diluent water depending upon the underlying chemical properties of the treated beer and desired endpoint pH.

The group B elements are prepared as a solution in purified water using the following salts:
Monobasic potassium phosphate (KH₂ PO₄)
Potassium bicarbonate (KHCO₃)
Sodium metasilicate (Na₂SiO₃.5H₂O)
Sodium bicarbonate (NaHCO₃)
Sodium chlorine (NaCl)

The quantities of these salts are added so that the group B solution contains the elements phosphorus, potassium, silicon, sodium and chlorine in the proportions required in the mineralized diluent water or concentrated preparation of group B. In the preparation of this solution some proportion of KHCO₃ and NaHCO₃ undergo the reactions KHCO₃+KH₂PO₄->K₂HPO₄+H₂O+CO₂ and 2NaHCO₃+2 KH₂PO₄->Na₂HPO₄+K₂HPO₄+2H₂O+2CO₂. The concentrated group B preparation takes, in part, the form of a stable colloid once the silicate is added.

A typical concentrate of group B can be prepared by dissolving 20 g of KH₂PO₄, 2 g of NaCl, 0.4 g of NaHCO₃, 0.7 g of Na₃SiO₃.5H₂O and 34 g of KHCO₃ per litre of water. This concentrate can be added directly to beer.

8 ml of concentrate per litre of beer adds 3.64 mg/L phosphorous, 9.7 mg/L chlorine, 8.4 mg/L sodium, 0.9 mg/L silicon and 141 mg/L potassium. Alternatively 8 ml of concentrate could be added per litre to a group A mineralized diluent solution to construct a combined group A and B mineralised diluent water with the same resulting addition of elements of group B above.

The group C elements are prepared in a single solution in purified water using the following salts:

| | |
|---|---|
| Sodium tetraborate¹ | Na₂B₄O₇•10H₂O |
| Chromium potassium sulphate^{2,3} | K[Cr(SO₆H₄)₂(H₂O)₂]•6H₂O |
| Cobalt Sulphate³ | CoSO₄•7H₂O |
| Cupric Sulphate³ | CuSO₄•5H₂O |
| Potassium Iodide² | KI |
| Lithium Sulphate³ | Li₂SO₄•H₂O |
| Manganous Sulphate³ | MnSO₄•H₂O |
| Sodium Molybdate¹ | Na₂MoO₄•H₂O |
| Nickel Sulphate³ | NiSO₄•6H₂O |
| Sodium Selenate¹ | Na₂SeO₄•10H₂O |
| Stannous Chloride⁴ | SnCl₂•H₂O |
| Ammonium Vanadate⁵ | NH₄VO₃ |
| Zinc Sulphate³ | ZnSO₄•7H₂O |

Notes
¹Sodium is added in (C) in addition to (B). This should be allowed for by either adjusting (B) or adjusting final sodium concentration to allow for sodium in (C). Note (C) adds μg levels as compared to mg levels in (B).
²Potassium is added in (C) in addition to (B). This should be allowed for by either adjusting (B) or adjusting final potassium concentration to allow for potassium in (C). Note (C) adds μg levels as compared to mg levels in (B).
³The final concentration of sulphate anion (SO₄²⁻) is determined by the concentrations of Cr⁺⁺, Co⁺⁺, Cu⁺⁺, Li⁺⁺, Mn⁺⁺, Ni⁺⁺ and Zn⁺⁺ in the mineralized drinking water.
⁴Chloride is added in (C) in addition to (B). This should be allowed for by either adjusting (B) or adjusting final chloride concentration to allow for chloride in (C). Note (C) adds μg levels as compared to mg levels in (B).
⁵Only very small amounts of nitrogen are present as ammonium NH₄⁺ cation.

A typical concentrate of group C may be prepared by dissolving per litre of solution 86.5 mg of sodium tetraborate, 0.70 mg of chromium potassium sulphate, 0.23 mg of Cobalt sulphate, 8.67 mg of cupric sulphate, 0.77 mg of potassium iodide, 4.52 mg of lithium sulphate, 0.60 mg of manganese sulphate, 0.62 mg of sodium molybate, 0.22 mg of nickel sulphate, 35.2 mg of sodium selenate, 0.92 mg of stannous chloride, 0.06 mg of ammonium vanadate, and 64.7 mg of zinc sulphate.

This concentrated can be added directly to beer. 2 ml of concentrate per litre of beer adds 20 μg of boron, 0.15 μg of chromium, 0.1 μg of cobalt, 4.5 μg of copper, 1.2 μg of iodine, 0.50 μg of lithium, 0.4 μg of manganese, 0.5 μg of molybdenum, 0.1 μg of nickel, 30 μg of selenium, 0.4 μg of tin, 0.05 μg of vanadium, and 30 μg of zinc.

Alternatively 2 ml of concentrate could be added per litre to a group A mineralized diluent water to construct a combined group A and C mineralized diluent water with the same resulting addition of elements of group C as above.

The group A, B, and C preparations can be premade and stored separately.

The group D element is made up freshly as a solution in purified water as FeSO₄.7H₂O (ferrous sulphate) which is prepared additionally and separately from C to avoid ferric cations, resulting from oxidation of ferrous cations (Fe⁺⁺->Fe⁺⁺⁺), contaminating solution C or deteriorating solution D. Ferrous sulphate may be added directly to base solution (C) for later use if oxidation can be prevented or it may be added immediately to make up the beverage. The ferrous sulphate is also preferably filtered prior to use to remove any insoluble ferric complexes that might be present in commercial sources. Please note: Note 3 above about (SO₄²⁻) also applies.

A typical concentrate of group D can be prepared by dissolving per liter of solution 14.6 mg of ferrous sulphate heptahydrate. This concentrate can be added directly to beer. 2 ml of concentrate per litre of beer adds 6 μg/L of iron. Alternatively 2 ml of concentrate can be added per litre to a group A mineralized diluent water to construct a combined group A and D mineralized diluent water with an iron concentration of 6 μg/L.

A typical mineralized diluent water containing groups A, B C and D could be constructed by adding to the above example of group A (900 ml) 8 ml of group B concentrate, 2 ml of group C concentrate and 2 ml of group D concentrate and 88 ml of water. The resulting concentrations of group A elements would be reduced to 60 mg/L (Ca) and 13.6 mg/L (Mg) and the concentrations of the group B, C and D elements would be the same as the amounts added respectively per litre of beer above.

Mineralized diluent waters with more or less concentration of constituent elements may be constructed by increasing of decreasing proportionately the concentration of calcium and magnesium salts in the initial group A suspension and adding proportionally more or less concentrates of groups B, C and D to maintain the desired proportions of all constituent elements.

A mineralized diluent water constructed from a group A solution generated with CO₂ to which are added concentrates of groups B, C and D would be expected to have a higher pH than the beer in which it would be a diluent. Therefore buffering acid would be added to the diluted beer or could be diluted out at a previously determined amount to the mineralized diluent water prior to diluting the base beer.

The pH of the final prepared mineralized diluent water is at the preferred level which is pH of between 3.8 to 4.5.

### Example 2

### Preparation and Addition of Mineral to the Datum Level

The compounds used as sources of minerals were all Analytical Grade and were all packaged by and purchased from Ace Chemical Company, 119A Mooringe Avenue, Camden Park, South Australia, Australia, and were as follows:
Ca—CaCO₃ (calcium carbonate)
Mg—MgCO₃ (magnesium carbonate)
P—Ca(H₂PO₄)₂ (Calcium dihydrogen phosphate) H₃PO₄ (Phosphoric acid)
K—KH₂PO₄ (Potassium dihydrogen phosphate) KHCO₃ (Potassium bicarbonate)
Na—NaH₂PO₄.2H₂O (Sodium dihydrogen phosphate)
Na—NaCl (Sodium Chloride) Na₂CO₃ (Sodium Carbonate)
Cl—NaCl (Sodium Chloride)
Si—Na₂SiO₃.5H₂O (Sodium silicate)
B—Na₂B₄O₇.10H₂O (Sodium tetraborate)
Cr—K[Cr(SO₆H₄)₂(H₂O)₂].6H₂O (Chromium potassium sulphate)
Co—CoSO₄.7H₂O (Cobalt Sulphate)
Cu—CuSO₄.5H₂O (Cupric Sulphate)
I—KI (Potassium Iodide)
Li—Li₂SO₄.H₂O (Lithium Sulphate)
Mn—MnSO₄.H₂O (Manganous Sulphate)
Mo—Na₂ MoO₄.H₂O (Sodium Molybdate)
Ni—NiSO₄.6H₂O (Nickel Sulphate)
Se—Na₂SeO₄.10H₂O (Sodium Selenate)
Sn—SnCl₂.H₂O (Stannous Chloride)
V—NH₄VO₃ (Ammonium Vanadate)
Zn—ZnSO₄.7H₂O (Zinc Sulphate)
Fe—FeSO₄.7H₂O (Ferrous Sulphate)

Concentrate was prepared in accordance with Example 1,

The concentrate contains the following per litre with pH adjusted with the addition of 9.96 g of H3PO4 added as a concentrated acid.

Group A—added at 6 ml litre of beer
per liter of concentrate

### 26.66 g of CaCO₃

### 8.38 MgCO₃

Group B—add 8 ml to 1 litre of beer
per liter of concentrate

### 20 g KH2PO4

### 2 g NaCl

### 0.4 g NaHCO3

### 0.7 g Na3SiO3.5H2O

### 34 g KHCO3

Group C—add 2 ml/Litre of beer
per litre of concentrate

### 86.5 mg Na₂B₄O₇.10H₂O

### 0.7 mg K[Cr(SO₆H₄)₂(H₂O)₂].6H₂O

### 0.23 mg CoSO₄.7H₂O

### 8.67 mg CuSO₄.5H₂O

### 0.77 mg KI

### 4.52 mg Li₂SO₄.H₂O

### 0.6 mg MnSO₄.H₂O

### 0.62 mg Na₂MoO₄.H₂O

### 0.22 mg NiSO₄.6H₂O

### 35.2 mg Na₂SeO₄.10H₂O

### 0.92 mg SnCl₂.H₂O

### 0.06 mg NH₄.VO₃

### 64.7 mg ZnSO₄.7H₂O

Group D—add 2 ml/litre of beer
per litre of concentrate

### 14.6 mg of FeSO₄.7H₂O

The amounts indicated above to one litre of beer is used as a datum, and assigned as a level of 1.0 amounts of the minerals. The level of minerals added to beer is to a final concentration of:

### Group A

Calcium 66.7 mg/L and magnesium 15.1 mg/L

### Group B

Phosphorous 3.64 mg/L, chlorine 9.7 mg/L, sodium 8.4 mg/L, silicon 0.9 mg/L and potassium 141 mg/L.

### Group C

Boron 20 μg/L, chromium 0.15 μg/L, cobalt 0.1 μg/L, copper 4.5 μg/L, iodine 1.2 μg/L, lithium 0.50 μg/L, manganese 0.4 μg/L, 0.5 μg of molybdenum, nickel 0.1 μL/L, selenium 30 μg/L, tin 0.4 μg/L of, vanadium 0.05 μg/L, and zinc 30 μg/L.

### Group D Elements

### Iron 6 μg/L.

This amount does not necessarily provide for an optimum enhancement of the specific beer concerned, but is used as a starting concentration with the amounts varied up and down to determine the optimum amount that should be added. Once the optimum enhancement is determined it is an easy matter to vary the concentrations up en bloc to assess an upper limit of minerals that still provide an enhancement, and to vary the concentrations down en bloc to determine the lower limit that still provides an enhancement.

### Example 3

### Modification of Flavours of Various Beers

In each case a range of strengths of the diluent water were added to the beers to ascertain a level of addition that gave the most favourable result. The methods set out are essentially as set out in example 3 below.

### James Squire Original Pilsener

This is a full strength pilsener with an alcohol content of 4.7% v/v.

Modified beers made by adding per liter 3.2 and 3.8 times the datum level as described in example 2 and 0.07 g/L of phosphoric acid buffer were superior to the unmodified pilsner beer. They had a reduced aftertaste bitterness on the tongue combined with more intense expression of flavours and even more approachable for drinking. The most preferred level of addition of concentrates was 3.6 times the strength of the datum.

### Southwark Old Stout.

This beer is a full strength stout beer with an alcohol content of 7.4% v/v.

Modified beers made by adding per liter 1.2 to 2.4 times the concentration of the datum and 0.035 g/L of phosphoric acid buffer were more approachable and had a broader flavour profile and reduced sharpness on the palate compared with the unmodified stout beers. The most preferred level of addition of concentrates was 1.5 times the strength of the datum level.

### West End Draught Beer

Is a full strength pale lager with an alcohol content of 4.5% v/v

Modified beers made by adding per litre 0.2 to 0.3 times the datum and 0.004 g/L of phosphoric acid buffer were more approachable because the modification reduced the influence of an ester component in the taste profile and exposed more malt flavour components. The most preferred level of addition of concentrates was 0.25 times the strength of the datum level.

### A Light Beer (2.7% Alcohol)

A range of light beers were constructed by diluting a full strength beer (5%) with minerals A, B, C and D added by way of mineralized diluent waters. Beer to which minerals were added to a final concentration of 1.8 to 2.0 times the datum and 0.02 g/L of phosphoric acid buffer were superior to light beers constructed using BP standard pure water as a diluent. The modified beers had enhanced aroma enhanced flavour profiles and greater length on the palate. The most preferred mineral content was 1.9 times the datum. Diluting full strength beers with BP (pure) water has the general effect of reducing aroma, reducing flavour and taste sensation, introduces a watery aftertaste with associated loss of retention of flavours in the palate.

### Example 4

### Sample Preparation and Tasting Protocol

The Methods of conducting these experiments were as follows:

Solutions of minerals for use in the examples were prepared using Analytical Grade chemicals, sources of which are set out in example, and distilled water. Concentrated mixes of group A, B, C and D minerals were prepared separately or combined and where required individual concentrates of each of the minerals were also prepared.

For some experimental samples, each of the minerals were added together to form a specific concentrate with each mineral being at a concentration such that the total addition of concentrate was between about 0.5 ml to 2.0 ml per 100 ml. Alternatively a standard concentrate of all of group A, B, C and D elements were prepared.

These specific concentrates were generally added to 100 ml sample of the undiluted commercial beers. For diluted samples the specific concentrates were combined with distilled water to a volume of 30 ml that was added to 70 ml of undiluted commercial beer to make diluted 100 ml samples.

A scoresheet was made up for each of the beer samples and the various taste components were scored. The scoresheet comprises a quantitative plot for each of the taste component. Central for each of the plots is a region marked as “acceptable”, and four other regions to encompass the ranges from absent (or very weak) to the opposing extreme sensations of taste (excessive, repulsive, saline, heavy, burnt, acidic, metallic, earthy and persistent) depending upon the component. For a given beer if all components are marked off in the acceptable region it will have a very good taste and any samples with all or most scores in the middle of the acceptable range has an exceptionally good taste profile. However, even if one or a few components are scored just outside of the acceptable region the taste will likely be satisfactory. However if more than about 3 are outside of the satisfactory region the overall taste of the beer will tend to be unsatisfactory and if many of the components are scored outside of ‘acceptable’ or near to ‘acceptable’, the overall taste of the beer is unsatisfactory and unacceptable.

Rating of each taste component is scored as a plot marked on the scoresheet and the result scored is thus a plot on a continuum. The ideal marking for each component is at the centre of the acceptable region. If the addition of minerals results in bringing a component's score into the acceptable region or towards the centre of the acceptable region an improvement for that taste component will have occurred. It will be appreciated from the data exhibited to this declaration that variation of the quantity of an added mineral or minerals may result in an improvement of one flavour component, scored by movement towards the centre of the acceptable range, but a deterioration of another, scored by moving further in either direction from the centre of the acceptable range.

Each taste component was individually tested and scored across all samples within one experiment, followed by the second taste component and so on until all components had been scored for all samples of the experiment.

Tasting was conducted as follows. An initial rinse of the mouth with pure water and tasting the first sample. Mouth was rinsed after tasting the first sample and allowing a few minutes before tasting the next sample. Where a particularly intense or persistent taste sensation was encountered it was sometimes necessary to rest a little longer.

Partitioning the overall taste sensation into components allows for objective description of each component and construction of a descriptive profile as opposed to an overall rating assessment by a taster.

The Taste Components tested and a brief explanation of each of these is as follows:
Aroma
This component is as ascertained by the olfactory senses. This taste component relies on the detection of volatile chemicals and accordingly can be absent, or weak whereon the impact may be minimal. Alternatively the volatile chemicals can produce a perception of pleasantness and are usually a combination of floral, fruity and spicy sensations and are therefore categorised as acceptable. On the other hand if the sensations from these compounds is too strong or contains compounds associated with unpleasant sensation such as aldehydes, esters and resins they will detract from the flavour of the beer and be considered excessive or repulsive.
Maltiness
Beers, by definition, are the product of fermenting grains and predominantly they are made from malt extracted from grain. Consequently there is an expectation that beers will have a ‘maltiness’ taste component. The acceptable level of maltiness results in a pleasant taste sensation. Unacceptable maltiness is associated with absence or weakness of a malt taste or a strong or excessive sensation of grain, flour, malt or mash.
Bitterness
Bitterness is a taste component which is created in beers by adding hops to the wort in sufficient quantity to produce isomerization of resins to a range of acids which stimulate the consumer's “bitter” taste receptors to a level which is considered pleasant and therefore acceptable. Insufficient levels of bitter compounds results in absent or weak levels of the ‘bitter’ sensation and excessive levels are also unacceptable because a ‘bitterness’ sensation predominates in taste.
Saltiness
‘Saltiness’ is determined in beer by the sensation produced by ions which stimulate the consumers’ ‘salt’ taste receptors. Stimulation at a level of a pleasant sensation is acceptable but insufficient or excessive stimulation results in weak or absent saltiness or strong and saline sensations respectively. Each extreme is unacceptable.
Sweetness
Sweetness is determined by the level of stimulation of the consumers’ ‘sweet’ taste receptors by compounds in the beer. Stimulation at a level of pleasant ‘sweet’ sensation is acceptable. The lack or weakness of sweetness or excessive ‘sugary’ taste sensations are both unacceptable.
Caramel (Burnt or Toasty)
The degree of caramelization in beer is mainly the result of management of wort boiling and cooling and adding roasted barley and other grain. The level of ‘caramel’ taste in beers is discretionary. Excessive caramelization is adverse in that it imparts a ‘burnt’ taste which is unacceptable while insufficient caramelization in beers, where it is intended, produces a weak insipid caramel taste and is also unacceptable. A greater complexity of caramel flavours also increases the acceptability of this taste component.
Sourness
Sourness is determined by the level of stimulation of the consumer's ‘sour’ taste receptors by sour and acid compounds in the beer. Stimulation at a modest level by a range of sour compounds is acceptable. A predominant sour or acidic taste is unacceptable while absent or weak ‘sourness’ sensation results in very unacceptable beers because of insufficient stimulation of ‘sour’ taste receptors.
‘Mineral’ Sensation
The presence of mineral element in beer which impart a taste sensation other than ‘saltiness’ or ‘calcic/magnesic’ components add to the overall complexity of flavour of beer. An excessively strong and metallic sensation is unacceptable while an absent or weak sensation also impacts adversely.
Calcic/Magnesic Sensation
This sensation results from the consumer's capacity to detect the distinctive taste of calcium and magnesium. If this sensation is too strong the beer tastes ‘earthy’ and is unacceptable while the absence or weakness of this component reduces the overall taste of the beer and is also unacceptable.
Body
The taste component which has ‘mouthfeel’ as an important aspect relates to the level of sensation when beer is held in the mouth. Beers with a very weak or weak ‘watery’ sensation when tasted are unacceptable. Excessive body results from the presence of one or more sub-components of mouthfeel, such as astringency and viscosity being excessive and having an adverse impact.
Initial Mouthfeel
This taste component relates to the level of sensation when the palate first encounters the beer. Beers in which one or more taste components are too strong and cause an adverse reaction are unacceptable. Conversely, beers which do not have sufficient initial flavour or complexity to impart a pleasant taste sensation impact adversely.
Persistence of Aftertaste
This taste component scores the degree and retention of flavours after the beer is swallowed or otherwise removed from the mouth. Beers with extended or persistent unpleasant taste components are unacceptable and beers having rapid dissipation of aftertaste are unacceptable. Some lingering of pleasant flavours is desirable.
It is pertinent to note that beers can have other usually deleterious taste components which were not considered in these experiments because they were not encountered. These include, stale, sulphuric, rancid, phenolic, acetyl and saponic components.

### Example 5

This experiment is designed to demonstrate that a range of concentration of minerals to enhance taste components of a given beer.

For the purposes of this example two ranges are provided

### Range 1

### Group A Minerals

calcium from 5.9 mg/L to 236 mg/L of beer and magnesium from 1.3 to 52 mg/L of beer;

### Group B Minerals

phosphorus from 3.0 to 360 mg/L of beer, potassium from 12 mg/L to 480 mg/L of beer, silicon at 0.075 mg/L to 30 mg/L of beer, sodium at 0.8 mg/L to 32 mg/L of beer and chlorine at 0.9 mg/L to 36 mg/L of beer;

### Group C Minerals

boron from 0 to 76 μg/L of beer, chromium from 0 to 0.4 μg/L of beer, cobalt from 0 to 0.4 μg/L of beer, copper from 0 to 17.2 μg/L of beer, iodine from 0 to 5.2 μg/L of beer, lithium from 0 to 1.6 μg/L of beer, manganese from 0 to 1.6 μg/L of beer, molybdenum from 0 to 2.0 μg/L of beer, nickel from 0 to 2.0 μg/L of beer, selenium from 0 to 136 μg/L of beer, tin from 0 to 01.6 μg/L of beer, vanadium from 0 to 0.12 μg/L of beer and zinc from 0 to 104 μg/L of beer; and
Group D minerals
iron 0 to 20 μg/L of beer

### Range 2

### Group A

calcium from 25 to 82 mg/L of beer and magnesium from 6 to 18 mg/L of beer;

### Group B

potassium from 50 to 180 mg/L of beer, silicon from 0.45 to 1.5 mg/L of beer, sodium from 3 to 30 mg/L of beer, chlorine from 3 to 28 mg/L of beer;

### Group C

boron from 0 to 0.060 mg/L of beer, chromium from 0 to 0.0005 mg/L of beer, cobalt from 0 to 0.0005 mg/L of beer, copper from 0 and 0.012 mg/L of beer, iodine from 0 to 0.006 mg/L of beer, lithium from 0 to 0.0015 mg/L of beer, manganese from 0 to 0.0015 mg/L of beer, molybdenum from 0 to 0.0015 mg/L of beer, nickel from 0 to 0.0005 mg/L of beer, selenium from 0 to 0.100 mg/L of beer, tin from 0 to 0.0015 mg/L of beer, vanadium from 0 to 0.1 mg/L of beer, and zinc from 0 and 0.100 mg/L of beer; and

### Group D

Iron from 0 to 0.020 mg/L of beer

Several 330 ml (approx 11.2 oz) bottles of Beck's and Heineken beer, and 440 ml cans of Guinness Beer were obtained from a retail liquor outlet. These beers are respectively a low alcohol beer, a lager and a dark beer.

Solutions of minerals for use in the above experiments were prepared as set out in Example 4. The specific amounts of ingredient can be found below for each one of the Experimental data for each experiment. All samples for one experiment were prepared with each sample being kept in a glass bottle with air tight closure.

The three commercial beers of example 3 plus invention were separately tested as follows:

| | |
|---|---|
| 1 | Commercial Beer (untreated) |
| 2 | Group A and group B minerals added as in datum |
| 3 | Group A and group B minerals added as in datum - |
| | except with Ca at the maximum of range 1 |
| 4 | Group A and group B minerals added as in datum - |
| | except with Ca at 25% more than the maximum of range 1 |
| 5 | Group A and group B minerals added as in datum - |
| | except with Mg at the maximum of range 1 |
| 6 | Group A and group B minerals added as in datum - |
| | except with Mg at 25% more than the maximum of range 1 |
| 7 | Group A and group B minerals added as in datum - |
| | except with P at the maximum of range 1 |
| 8 | Group A and group B minerals added as in datum - |
| | except with P at 25% more than the maximum of range 1 |
| 9 | Group A and group B minerals added as in datum - |
| | except with K at the maximum of range 1 |
| 10 | Group A and group B minerals added as in datum - |
| | except with K at 25% more than the maximum defined in range 1 |
| 11 | Group A and group B minerals added as in datum - |
| | except with Si at the maximum defined in range 1 |
| 12 | Group A and group B minerals added as in datum - |
| | except with Si at 25% more than the maximum defined in range 1 |
| 13 | Group A and group B minerals added as in datum - |
| | except with Na at the maximum of range 1 |
| 14 | Group A and group B minerals added as in datum - |
| | except with Na at 25% more than the maximum of range 1 |
| 15 | Group A and group B minerals added as in datum - |
| | except with Cl at the maximum of range 1 |
| 16 | Group A and group B minerals added as in datum - |
| | except with Cl at 25% more than the maximum of range 1 |
| 17 | Groups A, B, C and D minerals added as in datum |
| 18 | Groups A, B, C and D minerals added as in datum - |
| | except with groups C and D at the maximum of range 1 |
| 19 | Groups A, B, C and D minerals added as in datum - |
| | except with groups C and D at 25% more than the maximum of range |
| | 1 |

The minerals added to each beer sample in mg/L are as follows:

| | Ca | Mg | P | K | Si | Na | Cl |
|---|---|---|---|---|---|---|---|
| 1 | | | | | | | |
| 2 | 66.7 | 15.1 | 223.4 | 141 | 0.9 | 8.4 | 9.7 |
| 3 | 236 | 15.1 | 223.4 | 141 | 0.9 | 8.4 | 9.7 |
| 4 | 295 | 15.1 | 223.4 | 141 | 0.9 | 8.4 | 9.7 |
| 5 | 66.7 | 52 | 223.4 | 141 | 0.9 | 8.4 | 9.7 |
| 6 | 66.7 | 65 | 223.4 | 141 | 0.9 | 8.4 | 9.7 |
| 7 | 66.7 | 15.1 | 360 | 141 | 0.9 | 8.4 | 9.7 |
| 8 | 66.7 | 15.1 | 450 | 141 | 0.9 | 8.4 | 9.7 |
| 9 | 66.7 | 15.1 | 223.4 | 480 | 0.9 | 8.4 | 9.7 |
| 10 | 66.7 | 15.1 | 223.4 | 600 | 0.9 | 8.4 | 9.7 |
| 11 | 66.7 | 15.1 | 223.4 | 141 | 3.0 | 8.4 | 9.7 |
| 12 | 66.7 | 15.1 | 223.4 | 141 | 3.75 | 8.4 | 9.7 |
| 13 | 66.7 | 15.1 | 223.4 | 141 | 0.9 | 32 | 9.7 |
| 14 | 66.7 | 15.1 | 223.4 | 141 | 0.9 | 40 | 9.7 |
| 15 | 66.7 | 15.1 | 223.4 | 141 | 0.9 | 8.4 | 36 |
| 16 | 66.7 | 15.1 | 223.4 | 141 | 0.9 | 8.4 | 45 |
| 17* | 66.7 | 15.1 | 223.4 | 141 | 0.9 | 8.4 | 9.7 |
| 18** | 66.7 | 15.1 | 223.4 | 141 | 0.9 | 8.4 | 9.7 |
| 19*** | 66.7 | 15.1 | 223.4 | 141 | 0.9 | 8.4 | 9.7 |

*Additionally group C and D minerals as follows
B 20 g/L, Cr 0.15 g/L, Co 0.1 g/L, Cu 4.5 g/L, I 1.2 g/L, Li 0.5 g/L, Mn 0.4 g/L, Mo 0.5 g/L, Ni 0.1 g/L, Se 30 g/L, Sn 0.4 g/L, V 0.05 g/L, Zn 30 g/L, Fe 6 g/L.
**Additionally group C and D minerals as follows
B 76 g/L, Cr 0.4 g/L, Co 0.4 g/L, Cu 17.2 g/L, I 5.2 g/L, Li 0.5 g/L, Mn 1.6 g/L, Mo 2.0 g/L, Ni 2.0 g/L, Se 136 g/L, Sn 1.6 g/L, V 0.12 g/L, Zn 104 g/L, Fe 20 g/L.
***Additionally group C and D minerals as follows
B 95 g/L, Cr 0.5 g/L, Co 0.5 g/L, Cu 21.5 g/L, I 6.5 g/L, Li 2.0 g/L, Mn 2.0 g/L, Mo 2.5 g/L, Ni 2.5 g/L, Se 170 g/L, Sn 2.0 g/L, V 0.15 g/L, Zn 130 g/L, Fe 25 g/L.

### Results

The levels of minerals of “Sample 1” are the same levels of the datum (see example 2). The particular minerals and levels of range 1 in particular are tested in this experiment.

Becks Beer—Becks is generally a reasonably balanced beer except in having a low calcic/magnesic sensation. The caramel component is also low reflecting the beer making procedure to avoid significant caramelization as a desirable characteristics of this beer. With the addition of the datum levels of group A and B minerals (sample 2) the taste component generally improve, trending towards the centre of the acceptable region of the taste rating for each component. Both aroma and calcic/magnesic components moved to the acceptable rating.

Sample 3 comprises the same minerals as for sample 2 but with the addition of calcium to the upper level of range 1. The distribution of component ratings is still within the acceptable levels apart from aroma weakening. The acceptable rating for calcic/magnesic seen in sample 2 was maintained. Again the caramel component is intentionally low. In sample 4 calcium is added at 25% above the maximum level of range 1, and this takes 6 of the components outside of the “acceptable” range. The beer becomes too “calcic”. A similar effect can be seen with magnesium, which if added at the maximum level of range 1 keeps the beer within an acceptable level except for aroma, but if added at a level 25% beyond the maximum of range 1, 8 of the taste components move outside of the “acceptable” range.

Disregarding the caramel component in Beck's beer, at the maximum concentration of range 1 for group B elements (Phosphorous, Potassium, Silicon, Sodium and Chlorine) only 1, 1, 0, 3 and 2 taste components are outside the ‘acceptable’ rating respectively but when those elements are added individually at 25% more than the maximum of range 1 there is a marked increase to 7, 4, 3, 9 and 7 taste component ratings fall outside the ‘acceptable’ rating respectively and the movements from the ‘acceptable’ rating are generally greater.

The group C and D minerals were tested as a single addition, thus in sample 17 the group A, B, C and D minerals are added at the datum levels. The taste components generally improve tending towards the centre or slightly towards the stronger end of the acceptable region of the taste for each component except ‘caramel’ which is not applicable. Sample 18 is the same as 17 except that the groups C and D minerals are brought up to the maximum level of range 1. In sample 18 all components (except caramel) retained an ‘acceptable’ rating. Some moved towards slightly stronger expression, but the addition of C and D suppressed the calcic/magnesic component slightly. When the C and D minerals are added at 25% above the levels of range 1 the taste profile deteriorates beyond that of the original beer with 5 non-caramel components continuing the trend from sample 17 to 18 and extending out of the acceptable region.

The table below is a summary of the results. Similar summary tables are presented for each of the experiments performed. Thus each row representing each sample comprises a reflection of the taste score sheet, setting out the number of taste components that are categorised as either acceptable (central column as labelled) or falling in any one of the four other categories on each score sheet, two to the left of and two to the right of the acceptable category.

### Example 4

### Beck's Beer Summary Table

| | | | Acceptable | |
|---|---|---|---|---|
| 1 | 1 | 1 | 9 | |
| 2 | | | 11 | |
| 3 | | 1 | 10 | |
| 4 | | 4 | 5 | 2 |
| 5 | | 1 | 10 | |
| 6 | | 6 | 3 | 2 |
| 7 | | 1 | 10 | |
| 8 | | 2 | 4 | 5 |
| 9 | | 1 | 10 | |
| 10 | | 1 | 7 | 3 |
| 11 | | | 11 | |
| 12 | | | 8 | 3 |
| 13 | | 2 | 8 | 1 |
| 14 | | 6 | 2 | 3 |
| 15 | | | 9 | 2 |
| 16 | | 1 | 4 | 6 |
| 17 | | | 11 | |
| 18 | | | 11 | |
| 19 | | 1 | 5 | 5 |

### Heineken Beer

Similar trends can be seen with this beer as with Beck's beer. Heineken has a quite similar score to Beck's, being a generally balanced beer, but having weak calcic/magnesic component and a weak caramel component which would have probably been discretionary set at this low and just discernable level. The addition of group A and B minerals at datum levels raises the calcic/magnesic component to an acceptable level and intensifies the body, initial mouthfeel and aftertaste to stronger but still acceptable levels. Adding calcium to the maximum of range 1 (sample 3) weakens the aroma and slightly increases initial mouthfeel but maintains the calcic/magnesic and eight other components at an acceptable level. Taking calcium to 25% beyond the maximum of range 1 deteriorates 7 of the taste components beyond the acceptable level and disintegrates the overall taste of the beer.

The response to addition of magnesium to the maximum level of range 1 is very similar to that of calcium; aroma weakened and initial mouthfeel and aftertaste are slightly intensified, but the acceptable level of the calcic/magnesic component is maintained. However, increasing magnesium to 25% beyond range 1 moves the ratings of 6 components excluding caramel outside an acceptable rating and disintegrates the beer.

The ratings for addition of the group B elements for eleven taste components other than caramel reflect the patterns of calcium and magnesium.

The maximum of range 1 for phosphorous, potassium, silicon, sodium and chlorine all the components are in the acceptable ranges except for 4, 1, 1, 1 and 0 components for phosphorous to sodium respectively and in each of these 7 samples the rating is only marginally outside the acceptable range. In contrast when these elements are added individually at 25% higher than range 1, 8, 7, 7, 9 and 7 components were rated outside acceptable for the five elements respectively. All the samples with 25% extra minerals were very unpalatable and unbalanced taste components.

As with Becks beer addition of groups A, B, C and D at datum levels (sample 17) very much improves the flavour to a point where both the calcic/magnesic and the caramel components are brought into the acceptable range, and also the majority of the other flavour components are brought closer to the most ideal score. This beer is markedly better overall than commercial Heineken beer, reflecting the rating of all taste components in the acceptable range. Taking sample 17 and adding C and D minerals up to the maximum level of range 1 (sample 18) deteriorates the taste profile relative to that of sample 17. Three components are marginally outside the acceptable range, the result is still quite a good beer. In contrast addition of groups C and D at levels 25% beyond the maximum levels of range 1 moves the ratings for 7 of the 12 taste components outside of acceptable and deteriorates the overall taste to a point where it is no longer palatable.

### Example 4

### Heineken Summary Table

| | | Acceptable | |
|---|---|---|---|
| 1 | 1 | 10 | |
| 2 | | 11 | |
| 3 | 1 | 9 | 1 |
| 4 | 3 | 4 | 4 |
| 5 | 1 | 8 | 2 |
| 6 | 4 | 5 | 2 |
| 7 | 2 | 7 | 2 |
| 8 | 3 | 3 | 5 |
| 9 | | 10 | 1 |
| 10 | 3 | 4 | 4 |
| 11 | | 10 | 1 |
| 12 | 1 | 4 | 6 |
| 13 | | 10 | 1 |
| 14 | 6 | 2 | 3 |
| 15 | | 11 | |
| 16 | 2 | 4 | 5 |
| 17 | | 11 | |
| 18 | 1 | 9 | 1 |
| 19 | 1 | 5 | 5 |

### Guinness Beer

Commercial Guinness is a uni-dimensional beer with a strong taste of caramelized components. This is undoubtedly a discretionary brewing objective (in the tradition of dark Irish beers).

Accordingly it is less balanced than the other two beers used in this experiment. Five of the taste components are rated outside, or just outside, of the acceptable in the weak range and the caramel component is rated ‘strong’.

Addition of group A and B minerals at datum levels as shown in sample 2 brings all of the taste components apart from ‘aroma’ into the acceptable range and produces a beer with more acceptable overall flavour while retaining an acceptable, near strong, rating for the caramel component.

Increasing the concentrations of the individual elements of groups A and B minerals to the maximum of range 1 resulted in the movement of some taste components outside the acceptable range specifically for calcium (8), magnesium (3), phosphorous (5), potassium (3), silicon (3) sodium (3) and chlorine (5). Addition of groups C and D minerals to the maximum of range 1 resulted in 3 components being outside the acceptable range. About 20 of these ratings were only marginally outside the acceptable range. Apart from calcium these overall patterns of ratings fell between the commercial beer (6 outside) and the beers with datum levels of minerals added (1 outside i.e. aroma). Consequently, the beers with individual additions at the maximum of range 1 were comparable or higher in quality than the commercial beer but lower than the beers with most preferred amounts added.

When the concentrations of the individual elements of groups A and B and of all groups (A, B, C and D) of minerals are added at 25% above the maximum of range 1 all the sample beers were severely unbalanced, unpalatable and dissipated. The number of ratings outside the acceptable range were specifically for calcium (11), magnesium (11), phosphorous (10), potassium (8), silicon (10), sodium (7), chlorine (10) and C and D (10) and most were markedly removed from the acceptable range.

### Example 4

### Guinness Summary Table

| | | | Acceptable | | |
|---|---|---|---|---|---|
| Sample 1 | | 5 | 6 | 1 | |
| Sample 2 | | 1 | 11 | | |
| Sample 3 | 1 | 7 | 4 | | |
| Sample 4 | 1 | 9 | 1 | 1 | |
| Sample 5 | 1 | 2 | 9 | | |
| Sample 6 | 1 | 8 | 1 | 2 | |
| Sample 7 | | 2 | 7 | 3 | |
| Sample 8 | 1 | 5 | 2 | 2 | 2 |
| Sample 9 | | 2 | 9 | 1 | |
| Sample 10 | | 4 | 4 | 4 | |
| Sample 11 | | 2 | 9 | 1 | |
| Sample 12 | 1 | 6 | 2 | 3 | |
| Sample 13 | | 3 | 9 | | |
| Sample 14 | | 7 | 5 | | |
| Sample 15 | | 3 | 7 | 2 | |
| Sample 16 | 1 | 4 | 2 | 5 | |
| Sample 17 | | 2 | 10 | | |
| Sample 18 | | 3 | 9 | | |
| Sample 19 | | 9 | 2 | 1 | |

### Conclusion

These data show that the addition to commercial beers of minerals in accordance with this invention results in beer with superior taste compared with beers to which no minerals have been added.

Furthermore these data show that the addition of minerals at levels of range 1 define a limit of amounts that might be added to beer before having markedly adverse effects on taste components as demonstrated by the disruption from an acceptable rating when any element was added individually beyond the limits of range 1.

Addition of minerals within range 1 enhances the taste of finished commercial beers, with no material dilution.

Additionally this experiment demonstrated that alteration of individual elements has divergent effects on usually more than one taste component. By way of example we can look at the influence of varying minerals in undiluted Becks beer. Thus by the addition of excess calcium, predictably, the calcic/magnesic component is elevated beyond the acceptable range, however additionally, the mineral sensation, acidity and sweetness all drop below the acceptable range. Similarly other elements have an influence on more than one taste component.

The interaction of the three beers in this experiment and excessive amounts of the seven A and B elements and C and D elements as a group demonstrate that different element are most disruptive in the different beers and consequently a maximum level of range 1 defines a limit of concentrates that may be added to beer to effect an enhancement of taste. Specifically, the highest numbers of components disrupted from the acceptable rating by various elements or C and D combined were for Beck's Na (10), Mg, P, Cl (8) for Heineken Na (9), P (8), K, Si, Cl, C and D (7), and for Guinness Ca, Mg (11), P, Si, Cl, C and D (10) K (8). The most disruptive element differs for different beers and all the element when added at higher concentrations than range 1 were disruptive in one or more beers in many components of taste.

The data demonstrate that individual taste components are influenced by more than one mineral. For example for Beck's beer, for the sweetness component where Ca, Mg, P, Na and Cl are individually taken above the maximum (samples 4, 6, 8, 14 and 16 respectively), sweetness declines below acceptable, whereas for K, Si, or the C and D mineral group do not. Thus five of the minerals influence this one taste component. For the bitterness component where K, Si, and Cl are taken above the maximum claimed level bitterness intensified above the acceptable level, but Ca, Mg, P, Na and C and D did not move the rating from acceptable.

In contrast for Guinness beer where Ca and Mg are added above the maximum of claim 36 the sweetness intensifies above acceptable and Ca and Mg reduce bitterness below the acceptable rating. Comparisons between the beers for the disruptive effects of individual minerals or individual taste components will exemplify that addition of individual elements above the maximum of range 1 may reduce or increase the rating for individual taste components for different beers.

It can be seen therefore that the minerals are not in themselves a taste component. Taste components are influenced by each of the minerals differently between beers, and the end position of any taste component is the cumulative result of all the minerals generally having greater or lesser impact.

### Example 6

This experiment compares the effects on taste components of the restoration of minerals to diluted beers with the effects on taste components of the addition of minerals in accordance with the present invention.

The three commercial beers plus were treated as follows:

| | |
|---|---|
| 1 | Commercial Beer (untreated) |
| 2 | Commercial Beer diluted 30% |
| 3 | Commercial Beer diluted 30% group A, B, C and D at the minimum |
| | level of range 1 |
| 4 | Commercial Beer diluted 30% group A, B, C and D at the minimum |
| | level of range 2 |
| 5 | Commercial Beer diluted 30% group A, B, C and D at the datum |
| | level |
| 6 | Commercial Beer diluted 30% group A, B, C and D at the maximum |
| | level of range 2 |
| 7 | Commercial Beer diluted 30% group A, B, C and D at the maximum |
| | level of range 1 |

The minerals below were added to each sample to the final concentrations (mg/L) as set out below.

| | Ca | Mg | P | K | Si | Na | Cl |
|---|---|---|---|---|---|---|---|
| 1 | | | | | | | |
| 2 | | | | | | | |
| 3 | 5.9 | 1.3 | 3 | 12 | 0.08 | 0.8 | 0.9 |
| 4 | 25 | 6 | 89.4 | 50 | 0.45 | 3 | 3 |
| 5ⁱ | 66.7 | 15.1 | 223.4 | 141 | 0.9 | 8.4 | 9.7 |
| 6ⁱⁱ | 82 | 18 | 279 | 180 | 1.5 | 30 | 28 |
| 7 ⁱⁱⁱ | 236 | 52 | 360 | 480 | 3 | 32 | 36 |

ⁱalso the group A and B minerals as follows:
B 20 g/L, Cr 0.15 g/L, Co 0.1 g/L, Cu 4.5 g/L, I 1.2 g/L, Li 0.5 g/L, Mn 0.4 g/L, Mo 0.5 g/L, Ni 0.1 g/L, Se 30 g/L, Sn 0.4 g/L, V 0.05 g/L, Zn 30 g/L, Fe 6 g/L.
ⁱⁱalso the group A and B minerals as follows:
B 60 g/L, Cr 0.5 g/L, Co 0.5 g/L, Cu 12 g/L, 0.06 g/L, Li 0.15 g/L, Mn 0.15 g/L, Mo 0.15 g/L, Ni 0.05 g/L, Se 100 g/L, Sn 0.15 g/L, V 0.1 g/L, Zn 100 g/L, Fe 20 g/L.
ⁱⁱⁱalso the group A and B minerals as follows:
B 76 g/L, Cr 0.4 g/L, Co 0.4 g/L, Cu 17.2 g/L, I 5.2 g/L, Li 0.5 g/L, Mn 1.6 g/L, Mo 106 g/L, Ni 2.0 g/L, Se 136 g/L, Sn 1.6 g/L, V 0.12 g/L, Zn 104 g/L, Fe 20 g/L.

### Results

### Becks Beer

Disregarding the ‘caramel’ component as in experiment A, dilution of this beer by 30% moves the rating for 6 of the taste components out of the acceptable range to the weak side of the taste component scorecard. In addition, two components, aroma and calcic/magnesic, which were weak in the commercial beer were weakened further by dilution. When the minimum level of minerals of range 1 are added all 6 components weakened by dilution were restored to the acceptable range. Addition of minimum of the range of minerals of range 2 to diluted beers moves the ‘calcic/magnesic’ component almost to the acceptable range. Addition of minerals of groups A, B, C and D at the maximum level of range 2 restored 5 of the 6 components weakened by dilution although initial mouthfeel was marginally strong. Addition of the maximum level of minerals of range 1 restores the same 5 components and additionally moved calcic/magnesic into the acceptable range.

### Experiment B—Becks Summary Table

| | | | Acceptable | |
|---|---|---|---|---|
| Sample 1 | 1 | 1 | 9 | |
| Sample 2 | 3 | 5 | 3 | |
| Sample 3 | | 2 | 9 | |
| Sample 4 | | 2 | 9 | |
| Sample 5 | | 3 | 8 | |
| Sample 6 | | 3 | 7 | 1 |
| Sample 7 | | 2 | 9 | |

### Heineken Beer

Dilution of this beer moves 9 of the taste components out of the acceptable range to the weak side of the register.

Using the minimal levels of minerals of ranges 1 and 2, and the maximum levels of ranges 1 and 2 restored all 9 components and the calcic/magnesic component which is weak in the commercial beer to the most acceptable levels. Using datum levels (example 1 levels) of minerals brought most ratings closest to the midpoint of the acceptable rating.

### Experiment B—Heineken Summary Table

| | | | Acceptable |
|---|---|---|---|
| Sample 1 | | 1 | 10 |
| Sample 2 | 1 | 9 | 1 |
| Sample 3 | | | 11 |
| Sample 4 | | | 11 |
| Sample 5 | | | 11 |
| Sample 6 | | | 11 |
| Sample 7 | | | 11 |

### Guinness Beer

Dilution of this beer by 30% deteriorates all flavour components, including caramel, significantly, such that the beer has becomes very weak and unstructured.

Addition of minimal level of minerals of ranges 1 and 2 restored 5 components to the acceptable range, and significantly enhanced the flavour of the diluted beer. Addition of datum levels of minerals brings the taste of the beer right back. Similarly where the maximum levels of minerals of ranges 1 and 2 are added, most components are restored to, or near to, the acceptable range, but not quite as well as with addition of the most preferred levels.

### Experiment B—Guinness Summary Table

| | | | Acceptable | |
|---|---|---|---|---|
| Sample 1 | | 5 | 6 | 1 |
| Sample 2 | 6 | 6 | 0 | |
| Sample 3 | | 7 | 5 | |
| Sample 4 | | 7 | 5 | |
| Sample 5 | | 2 | 10 | |
| Sample 6 | | 3 | 8 | 1 |
| Sample 7 | | 5 | 5 | 2 |

### Conclusion

In all three diluted beers addition of minerals within ranges 1 and 2 significantly enhanced taste, particularly at datum levels, whereas restoring the minerals depleted by dilution to levels as present in the undiluted beer was ineffective.

Addition of minerals within ranges 1 and 2 to the diluted beers also moved into the acceptable range some components which were weak in the undiluted commercial beers (saltiness and sweetness in Guinness and calcic/magnesic in all three beers), reflecting the enhancement of these components which also occurred when the claimed minerals were added to the undiluted commercial (see Experiment A).

### Example 7

Rapid testing for determining the level of minerals to be added for optimal taste enhancement.

Methods set out in example 4 were used to test the effect of addition of minerals to the present of the method of the present invention.

As a first screening four samples were tested, 1) control with no additive, 2) concentrate added at 0.15 m/50 ml, 3) concentrate added at 0.3 ml/100 ml—the datum level, and 4) 0.6 ml/50 ml. In most cases the optimum range of concentrations falls within this range tested, and one or two further samples can be tested to determine the optimum amount, and therefore final concentration of minerals.

In other case the optimum amount lay beyond sample 4, and therefore additional amounts of concentrated ABCD mix was added.

This simple and straightforward means can readily improve the flavour of a wide range of beers.

To further adjust taste components other variation can be made for individual elements of groups of elements.

### Results

### Millers Genuine Draft

A full strength pale lager with an alcohol content of 4.7% v/v.
The optimum is 1.4

### Budweisser

Is a full strength pale lager with an alcohol content of 5.0% v/v
The optimum is 3.0

### Corona

A pale lager with 4.6% v/v alcohol
The optimum is 1.5

### Cascade Premium Light

A light lager with 2.8% v/v alcohol
The optimum is 1.2

### Little Creatures Pale Ale

A pale ale with 4.5% v/v alcohol
The optimum is 0.9

### Coopers Original Pale Ale

A pale ale with 4.5% v/v alcohol
The optimum is 0.75 (0.24 ml/100 ml)
James Squires 150 lashes Pale Ale
A pale ale with 4.2% v/v alcohol
The optimum is 0.8

### Little Creatures Bright Ale

A bright ale with 4.5% alcohol
The optimum is 1.0 (0.30 ml/100 ml)

### James Squire Nine Tales Amber Ale

An amber ale with 5.0% v/v alcohol
The optimum is 0.8

### Toohey Old Draught Ale

A draft ale with 4.4% v/v alcohol
The optimum is 1.2

### Carlton Black Dark Ale

A dark ale with 4.4% v/v alcohol
The optimum is 1.2

### Matilda Bay Honey Wheat Beer

Wheat beer with 4.7% v/v alcohol
The optimum is 1.1

### Cubanero Fuerte

A lager with 5.4% v/v alcohol

### Optimum 0.75

Schöfferhofe Hefeweizen Beer
A wheat beer 5.0% v/v alcohol

### Optimum 0.9

### Bombardier Wells Bitter Beer

A bitter beer with 5.2% v/v alcohol

### Optimum 1.5

Unicer Authentic beer Super Bock (Portugal)
Bock beer with 5.2% v/v alcohol

### Optimum 1.1

### Manns Brown Ale

Brown Ale—a Lite ale with 2.8% v/v alcohol

### Optimum 1.0

### Samuel Smith's Imperial Stout

A stout beer with 7% v/v alcohol
Optimum 1.1

What is claimed is:

1. A method for enhancing taste characteristics of a beer comprising:
providing a beer;
adding minerals to the beer, the minerals consisting of:
group A minerals being calcium added in the range of 5.9 mg/L to 236 mg/L of beer and magnesium added in the range of 1.3 to 52 mg/L of beer;
group B minerals being phosphorus added in the range of 3.0 to 360 mg/L of beer, potassium added in the range of 12 mg/L to 480 mg/L of beer, silicon added in the range of 0.075 mg/L to 30 mg/L of beer, sodium added in the range of 0.8 mg/L to 32 mg/L of beer and chlorine added in the range of 0.9 mg/L to 36 mg/L of beer;
group C minerals being boron added in the range of 0 to 76 μg/L of beer, chromium added in the range of 0 to 0.4 μg/L of beer, cobalt added in the range of 0 to 0.4 μg/L of beer, copper added in the range of 0 to 17.2 μg/L of beer, iodine added in the range of 0 to 5.2 μg/L of beer, lithium added in the range of 0 to 1.6 μg/L of beer, manganese added in the range of 0 to 1.6 μg/L of beer, molybdenum added in the range of 0 to 2.0 μg/L of beer, nickel added in the range of 0 to 2.0 μg/L of beer, selenium added in the range of 0 to 136 μg/L of beer, tin added in the range of 0 to 1.6 μg/L of beer, vanadium added in the range of 0 to 0.12 μg/L of beer and zinc added in the range of 0 to 104 μg/L of beer; and
group D minerals being iron added in the range of 0 to 20 μg/L of beer;
wherein the mineral additive enhances the taste characteristics of the beer compared to the taste provided by a beer to which the mineral additive has not been added.

2. The method according to claim 1, wherein
for the group C minerals boron is added in the range of 5.0 to 76 μg/L of beer, chromium is added in the range of 0.04 to 0.4 μg/L of beer, cobalt is added in the range of 0.025 to 0.4 μg/L of beer, copper is added in the range of 1.1 to 17.2 μg/L of beer, iodine is added in the range of 0.3 to 5.2 μg/L of beer, lithium is added in the range of 0.1 to 1.6 μg/L of beer, manganese is added in the range of 0.1 to 1.6 μg/L of beer, molybdenum is added in the range of 0.1 to 2.0 μg/L of beer, nickel is added in the range of 0.025 to 2.0 μg/L of beer, selenium is added in the range of 7.0 to 136 μg/L of beer, tin is added in the range of 0.1 to 1.6 μg/L of beer, vanadium is added in the range of 0.01 to 0.12 μg/L of beer and zinc is added in the range of 7.0 to 104 μg/L of beer; and
for the group D minerals iron is added in the range of 1.0 to 20 μg/L of beer.

3. The method according to claim 1, further comprising the step of diluting the beer with water between 0.5% and 90% of its original strength before adding the minerals.

4. The method according to claim 1, wherein at least some of the minerals of groups A, B, C and D is added in dry form.

5. The method according to claim 1, wherein the beer is a stout beer and the mineral are added as follows:
for group A minerals calcium is added in the range of 70 mg/L to 143 mg/L of beer and magnesium is added in the range of 15 mg/L to 32 mg/L of beer;
for the group B minerals phosphorus is added in the range of 36 mg/L to 360 mg/L of beer, potassium is added in the range of 144 mg/L to 288 mg/L of beer, silicon is added in the range of 9 mg/L to 18 mg/L of beer, sodium is added in the range of 9 mg/L to 20 mg/L of beer and chlorine is added in the range of 11 mg/L to 22 mg/L of beer;
for the group C minerals boron is added in the range of 23 to 46 μg/L of beer, chromium is added in the range of 0.12 to 0.24 μg/L of beer, cobalt is added in the range of 0.12 to 0.24 μg/L of beer, copper is added in the range of 5 to 11 μg/L of beer, iodine is added in the range of 1.5 to 3.5 μg/L of beer, lithium is added in the range of 0.45 to 1.00 μg/L of beer, manganese is added in the range of 0.45 to 1.00 μg/L of beer, molybdenum is added in the range of 0.6 to 1.2 μg/L of beer, nickel is added in the range of 0.6 to 1.2 μg/L of beer, selenium is added in the range of 40 to 82 μg/L of beer, tin is added in the range of 0.45 to 1.00 μg/L of beer, vanadium is added in the range of 0.035 to 0.075 μg/L of beer and zinc is added in the range of 31 to 62 μg/L of beer; and
for the group D minerals iron is added in the range of 6 to 12 μg/L of beer.

6. The method according to claim 1, wherein, if present in the beer, iron is provided in the form of FeSO₄.7H₂O (ferrous sulphate).

7. The method according to claim 1, wherein the beer is a pilsner beer and the minerals are added as follows:
for the group A minerals calcium is added in the range of 188 mg/L to 224 mg/L of beer and magnesium is added in the range of 41 mg/L to 50 mg/L of beer;
for the group B minerals phosphorus is added in the range of 96 mg/L to 360 mg/L of beer, potassium is added in the range of 380 mg/L to 460 mg/L of beer, silicon is added in the range of 24 mg/L to 29 mg/L of beer, sodium is added in the range of 25 mg/L to 31 mg/L of beer and chlorine is added in the range of 28 mg/L to 35 mg/L of beer;
for the group C minerals boron is added in the range of 60 to 73 μg/L of beer, chromium is added in the range of 0.3 to 0.4 μg/L of beer, cobalt is added in the range of 0.3 to 0.4 μg/L of beer, copper is added in the range of 13 to 17 μg/L of beer, iodine is added in the range of 4 to 5 μg/L of beer, lithium is added in the range of 1.2 to 1.6 μg/L of beer, manganese is added in the range of 1.2 to 1.6 μg/L of beer, molybdenum is added in the range of 1.5 to 2.0 μg/L of beer, nickel is added in the range of 1.5 to 2.0 μg/L of beer, selenium is added in the range of 40 to 82 μg/L of beer, tin is added in the range of 1.2 to 1.6 μg/L of beer, vanadium is added in the range of 0.09 to 0.12 μg/L of beer, and zinc is added in the range of 83 to 99 μg/L of beer; and
for the group D minerals iron is added in the range of 16 to 19 μg/L of beer.

8. The method according to claim 1, wherein the beer is a light beer and the minerals are added as follows:
for the group A minerals calcium is added in the range of 11 mg/L to 21 mg/L of beer and magnesium is added in the range of 2.6 to 4.6 mg/L of beer;
for the group B minerals phosphorus is added in the range of 6 mg/L to 360 mg/L of beer, potassium is added in the range of 24 mg/L to 42 mg/L of beer, silicon is added in the range of 1.5 mg/L to 2.7 mg/L of beer, sodium is added in the range of 1.5 mg/L to 2.8 mg/L of beer and chlorine is added in the range of 1.8 mg/L to 3.2 mg/L of beer;
for the group C minerals boron is added in the range of 3.5 to 7 μg/L of beer, chromium is added in the range of 0.02 to 0.035 μg/L of beer, cobalt is added in the range of 0.02 to 0.035 μg/L of beer, copper is added in the range of 0.8 to 1.6 μg/L of beer, iodine is added in the range of 0.25 to 0.5 μg/L of beer, lithium is added in the range of 0.08 to 0.14 μg/L of beer, manganese is added in the range of 0.08 to 0.14 μg/L of beer, molybdenum is added in the range of 0.1 to 0.18 μg/L of beer, nickel is added in the range of 0.1 to 0.18 μg/L of beer, selenium is added in the range of 6.8 to 12 μg/L of beer, tin is added in the range of 0.08 to 0.14 μg/L of beer, vanadium is added in the range of 0.006 to 0.011 μg/L of beer and zinc is added in the range of 5 to 9.5 μg/L of beer; and
for the group D minerals iron is added in the range of 1 to 1.8 μg/L of beer.

9. The method according to claim 1, wherein the beer is an extra light beer and the minerals are added as follows:
for the group A minerals calcium is added in the range of 23 mg/L to 42 mg/L of beer and magnesium is added in the range of 5 to 9.5 mg/L of beer;
for group B minerals phosphorus is added in the range of 12 mg/L to 360 mg/L of beer, potassium is added in the range of 48 mg/L to 84 mg/L of beer, silicon is added in the range of 3 mg/L to 5.3 mg/L of beer, sodium is added in the range of 3.2 mg/L to 5.6 mg/L of beer, and chlorine is added in the range of 3.6 mg/L to 6.3 mg/L of beer;
for the group C minerals boron is added in the range of 7.5 to 14 μg/L of beer, chromium is added in the range of 0.04 to 0.07 μg/L of beer, cobalt is added in the range of 0.04 to 0.07 μg/L of beer, copper is added in the range of 1.7 to 3.2 μg/L of beer, iodine is added in the range of 0.5 to 1.0 μg/L of beer, lithium is added in the range of 0.15 to 0.3 μg/L of beer, manganese is added in the range of 0.15 to 0.3 μg/L of beer, molybdenum is added in the range of 0.2 to 0.35 μg/L of beer, nickel is added in the range of 0.2 to 0.35 μg/L of beer, selenium is added in the range of 13 to 24 μg/L of beer, tin is added in the range of 0.15 to 0.3 μg/L of beer, vanadium is added in the range of 0.012 to 0.021 μg/L of beer, and zinc is added in the range of 10 to 19 μg/L of beer; and
for the group D minerals iron is added in the range of 1 to 3.5 μg/L of beer.

10. The method according to claim 1, wherein the beer is a medium strength beer and the minerals are added as follows:
for the group A minerals calcium is added in the range of 11 mg/L to 23 mg/L of beer and magnesium is added in the range of 2.6 to 5 mg/L of beer;
for the group B minerals phosphorus is added in the range of 6 mg/L to 360 mg/L of beer, potassium is added in the range of 24 mg/L to 48 mg/L of beer, silicon is added in the range of 1.5 mg/L to 3 mg/L of beer, sodium is added in the range of 1.6 mg/L to 3.2 mg/L of beer, and chlorine is added in the range of 6.8 mg/L to 3.6 mg/L of beer;
for the group C minerals boron is added in the range of 3.5 to 8 μg/L of beer, chromium is added in the range of 0.02 to 0.04 μg/L of beer, cobalt is added in the range of 0.02 to 0.04 μg/L of beer, copper is added in the range of 0.8 to 1.8 μg/L of beer, iodine is added in the range of 0.25 to 0.5 μg/L of beer, lithium is added in the range of 0.08 to 0.15 μg/L, manganese is added in the range of 0.08 to 0.15 μg/L, molybdenum is added in the range of 0.1 to 0.2 μg/L, nickel is added in the range of 0.1 to 0.2 μg/L, selenium is added in the range of 6.8 to 13 μg/L, tin is added in the range of 0.08 to 0.15 μg/L of beer, vanadium is added in the range of 0.005 to 0.012 μg/L of beer, and zinc is added in the range of 5 to 10 μg/L of beer; and
for the group D minerals iron is added in the range of 1 to 2 μg/L of beer.

11. The method according to claim 1, wherein the beer is a full strength beer and the minerals are added to the beer as follows:
for the group A minerals calcium is added in the range of 17 mg/L to 36 mg/L of beer and magnesium is added in the range of 3.9 to 7.8 mg/L of beer;
for the group B minerals phosphorus is added at least at about 9 mg/L of beer, potassium is added in the range of 36 mg/L to 72 mg/L of beer, silicon is added in the range of 2.2 mg/L to 4.5 mg/L of beer, sodium is added in the range of 2.4 mg/L to 4.8 mg/L of beer, and chlorine is added in the range of 2.5 mg/L to 5.5 mg/L of beer;
for the group C minerals boron is added in the range of 5.5 to 11.5 μg/L of beer, chromium is added in the range of 0.03 to 0.06 μg/L of beer, cobalt is added in the range of 0.03 to 0.06 μg/L of beer, copper is added in the range of 1.2 to 2.6 μg/L of beer, iodine is added in the range of 0.3 to 0.8 μg/L of beer, lithium is added in the range of 0.12 to 0.24 μg/L of beer, manganese is added in the range of 0.12 to 0.24 μg/L of beer, molybdenum is added in the range of 0.15 to 0.3 μg/L of beer, nickel is added in the range of 0.15 to 0.3 μg/L of beer, selenium is added in the range of 10 to 21 μg/L of beer, tin is added in the range of 0.12 to 0.24 μg/L of beer, vanadium is added in the range of 0.009 to 0.02 μg/L of beer, and zinc is added in the range of 7.5 to 16 μg/L of beer; and
for the group D minerals iron is added in the range of 1.5 to 3 μg/L of beer.

12. The method according to claim 1, wherein the minerals are added to the beer as follows:
for the group A minerals, calcium is added in the range of 25 to 82 mg/L of beer and magnesium is added in the range of 6 to 18 mg/L of beer;
for the group B minerals, potassium is added in the range of 50 to 180 mg/L of beer, silicon is added in the range of 0.45 to 1.5 mg/L of beer, sodium is added in the range of 3 to 30 mg/L of beer, chlorine is added in the range of 3 to 28 mg/L of beer;
for the group C minerals, boron is added in the range of 0.005 to 0.060 mg/L of beer, chromium is added in the range of 0.00004 to 0.0005 mg/L of beer, cobalt is added in the range of 0.000025 to 0.0005 mg/L of beer, copper is added in the range of 0.00011 and 0.012 mg/L of beer, iodine is added in the range of 0.00003 to 0.006 mg/L of beer, lithium is added in the range of 0.00001 to 0.0015 mg/L of beer, manganese is added in the range of 0.00001 to 0.0015 mg/L of beer, molybdenum is added in the range of 0.00001 to 0.0015 mg/L of beer, nickel is added in the range of 0.0000025 to 0.0005 mg/L of beer, selenium is added in the range of 0.0007 to 0.100 mg/L of beer, tin is added in the range of 0.00001 to 0.0015 mg/L of beer, vanadium is added in the range of 0.000001 to 0.1 mg/L of beer, and zinc is added in the range of 0.0007 and 0.100 mg/L of beer; and
for the group D minerals iron is added in the range of 0.0001 to 0.020 mg/L of beer.

13. The method according to claim 1, further comprising separately preparing the group A minerals and adding a buffer or acid to the group A minerals to adjust the pH of the group A minerals before addition to the beer.

14. The method according to claim 3, wherein the dilution is between 0.5% and 50%.

15. A method for enhancing taste of a beer comprising:
providing a beer;
diluting the beer between 20% and 90%;
adding minerals to the diluted beer, the minerals consisting of:
group A minerals added in the range of calcium added in the range of 5.9 mg/L to 236 mg/L of beer and magnesium added in the range of 1.3 to 52 mg/L of beer;
group B minerals being phosphorus added in the range of 3.0 to 360 mg/L of beer, potassium added in the range of 12 mg/L to 480 mg/L of beer, silicon added in the range of 0.075 mg/L to 30 mg/L of beer, sodium added in the range of 0.8 mg/L to 32 mg/L of beer, and chlorine added in the range of 0.9 mg/L to 36 mg/L of beer;
group C minerals being boron added in the range of 0 to 76 μg/L of beer, chromium added in the range of 0 to 0.4 μg/L of beer, cobalt added in the range of 0 to 0.4 μg/L of beer, copper added in the range of 0 to 17.2 μg/L of beer, iodine added in the range of 0 to 5.2 μg/L of beer, lithium added in the range of 0 to 1.6 μg/L of beer, manganese added in the range of 0 to 1.6 μg/L of beer, molybdenum added in the range of 0 to 2.0 μg/L of beer, nickel added in the range of 0 to 2.0 μg/L of beer, selenium added in the range of 0 to 136 μg/L of beer, tin added in the range of 0 to 01.6 μg/L of beer, vanadium added in the range of 0 to 0.12 μg/L of beer, and zinc added in the range of 0 to 104 μg/L of beer; and
group D minerals being iron added in the range of 0 to 20 μg/L of beer;
gassing with carbon dioxide to thereby carbonate the beer;
wherein the mineral additive enhances taste characteristics of the beer compared to the taste provided by a beer diluted solely with water.

16. The method according to claim 15, wherein
for the group C minerals boron is added in the range of 5.0 to 76 μg/L of beer, chromium is added in the range of 0.04 to 0.4 μg/L of beer, cobalt is added in the range of 0.025 to 0.4 μg/L of beer, copper is added in the range of 1.1 to 17.2 μg/L of beer, iodine is added in the range of 0.3 to 5.2 μg/L of beer, lithium is added in the range of 0.1 to 1.6 μg/L of beer, manganese is added in the range of 0.1 to 1.6 μg/L of beer, molybdenum is added in the range of 0.1 to 2.0 μg/L of beer, nickel is added in the range of 0.025 to 2.0 μg/L of beer, selenium is added in the range of 7.0 to 136 μg/L of beer, tin is added in the range of 0.1 to 1.6 μg/L of beer, vanadium is added in the range of 0.01 to 0.12 μg/L of beer and zinc is added in the range of 7.0 to 104 μg/L of beer; and
for the group D minerals iron is added in the range of 1.0 to 20 μg/L of beer.

16. The method according to claim 1, further comprising diluting the beer between 0.5% and 5% prior to the step of adding the mineral additive.

17. The method according to claim 15, wherein:
phosphorous is provided or partially provided in the form of KH₂PO₄ (monobasic potassium phosphate);
potassium is provided or partially provided in the form of KH₂PO₄ (monobasic potassium phosphate) or KHCO₃ (potassium bicarbonate);
silicon is provided in the form of Na₂SiO₃.5H₂O (sodium metasilicate);
sodium is provided wholly or partially in a form selected from the group consisting of NaHCO₃ (sodium bicarbonate), Na₂B₄O₇.10H₂O (sodium tetraborate), NaCl (sodium chloride), Na₂MoO₄.2H₂O (sodium molybdate), Na₂SeO₄.10H₂O (sodium selenate), Na₂SeO₃ (sodium selenite), Na₂SiO₃.5H₂O (sodium silicate), Na₂SO₄ and Na₂SO₄.10H₂O (sodium sulphate); and
chlorine is provided wholly or partially in a form selected from the group consisting of NaCl (sodium chloride), KCl (potassium chloride), CaCl₂ (calcium chloride) and MgCl₂ (magnesium chloride).

18. The method according to claim 1, wherein, if present in the beer,
boron is provided wholly or partially in a form selected from one of the groups consisting of Na₂B₄O₇.10H₂O (sodium tetraborate) and K₂B₄O₇.5H₂O (potassium tetraborate);
chromium is provided in the form K[Cr(SO₆H₄)₂(H₂O)₂].6H₂O (chromium potassium sulphate);
cobalt is provided wholly or partially in a form selected from one or more of the groups consisting of CoK₂(SO₄)₂.6H₂O (cobaltous potassium sulphate) and CoSO₄.7H₂O (cobalt sulphate);
copper is provided wholly or partially in a form selected from one or more of the groups consisting of CuSO₄.5H₂O (cupric sulphate) and CuSeO₄.5H₂O (cupric selenate);
iodine is provided as (KI) potassium iodide;
lithium is provided wholly or partially in a form selected from one or more of the groups consisting of Li₂SO₄.H₂O (lithium sulphate), LiCl (lithium chloride) or Li₂SeO₄.H₂O (lithium selenate);
manganese is provided wholly or partially in a form selected from one or more of the groups consisting of MnSO₄.H₂O (manganous sulphate) MnCl₂.4H₂O (manganous chloride);
molybdenum is provided in the form of Na₂MoO₄.2H₂O (sodium molybdate); nickel is provided in the form of NiSO₄.6H₂O (nickel sulphate);
selenium is provided wholly or partially in a form selected from one or more of the groups consisting of Na₂SeO₄.10H₂O (sodium selenate), K₂SeO₄ (potassium selenate), MgSeO₄ (magnesium selenate) and Na₂SeO₃ (sodium selenite);
tin is provided in the form of Tin SnCl₂.2H₂O (stannous chloride);
vanadium is provided in the form of NH₄VO₃ (ammonium vanadate); and
zinc is provided wholly or partially in a form selected from one or more of the groups consisting of ZnSO₄.H₂O and ZnSO₄.7H₂O (zinc sulphate).

19. A beer made in accordance with claim 1.
